(19) United States
(12) Patent Application Publication
(10) Pub. No.: US 2020/0005396 A1
(43) Pub. Date: Jan. 2, 2020

(54) Risk Factor Splitting

(71) Applicant: Axioma, Inc., New York, NY (US)

(72) Inventor: Anthony A. Renshaw, New York, NY (US)

(21) Appl. No.: 16/552,129

(22) Filed: Aug. 27, 2019

Related U.S. Application Data
(63) Continuation of application No. 14/495,470, filed on Sep. 24, 2014, now abandoned.

(51) Int. Cl. G06Q 40/06; G06Q 40/04

(52) U.S. Cl. CPC G06Q 40/06; G06Q 40/04

(57) ABSTRACT

Factor-based performance attribution results are often used to identify portfolio exposures or bets that either perform well or underperform. By identifying particular exposures or bets that appear to be opportune to be increased or reduced, the overall performance of the portfolio can potentially be improved. However, the factors present in standard factor risk models are often too broad to identify exposures or bets which can be easily altered. Changing exposures based on the original risk model factors can involve trading too many stocks, or can involve trading stocks that a portfolio manager may not want to trade. The present invention allows portfolio managers to split the original risk model factors into more granular factors that cover smaller sub-sets of the assets in the portfolio. The over- and under-performing exposures of split factors are often easier to alter in practice and can be used to improve the performance of the portfolio.

The present application is a continuation under 35 U.S.C. 120 of U.S. application Ser. No. 14/495,470 filed Sep. 24, 2014 entitled Risk Factor Splitting which is assigned to the assignee of the present application and incorporated by reference in its entirety.

### FIELD OF INVENTION

The present invention relates generally to methods and apparatus for calculating factor-based performance attribution results for investment portfolios using factor risk models. More particularly, it relates to improved computer based systems, methods and software for calculating performance attribution results using more granular factors than are present in the original factor risk model.

### BACKGROUND OF THE INVENTION

Factor-based performance attribution is one technique that can be used to explain the historical sources of return of a portfolio. Factor-based performance attribution results are often used to identify portfolio exposures or bets that either perform well or under-perform. By identifying prospective exposures or bets to be increased or reduced, the overall performance of the portfolio can potentially be improved. However, the factors present in standard factor risk models are often too broad to identify exposures or bets that can be easily altered. Changing exposures based on the original risk model factors can involve trading too many stocks, or can involve trading stocks that a portfolio manager may not want to trade.

Factor-based performance attribution relies on factor and specific return models to decompose and explain the return of the portfolio in terms of various separate contributions. Often, the factor and specific return models are associated with a factor risk model. The portion of the portfolio return that can be explained by the factors is called the factor contribution. The remainder of the return is called the asset-specific or residual contribution.

Many portfolio managers construct their portfolios with explicit exposures to quantitative factors. These quantitative factors are often associated with the returns or risk of individual assets. These quantitative factors can be risk factors of a factor risk model. For example, many portfolios are constructed to have large exposures to factors that are perceived to drive positive returns. Such factors are often called alpha factors or alpha signals. In addition, the aggregate exposure of a portfolio to other quantitative factors may be limited to lie within certain bounds. For example, portfolios are sometimes constructed so that their net exposure to any sector is within 10% of the exposure to the sector for a particular benchmark. Factor-based performance attribution for these kinds of portfolios can show significant contributions arising from the targeted or constrained factors.

Some portfolio managers construct and use a custom risk model containing proprietary factors, often alpha factors, as the risk model factors. These proprietary factors are signals that the portfolio manager believes will either out-perform the market or will describe market performance well. Factor-based performance attribution using the factors of a custom risk model with proprietary factors decomposes performance across the proprietary signals. These results can be used to evaluate whether or not the signals thought to drive performance actually did.

In mean-variance optimization, a portfolio is constructed that minimizes the risk of the portfolio while achieving a minimum acceptable level of return. Alternatively, the level of return is maximized subject to a maximum allowable portfolio risk. The family of portfolio solutions solving these optimization problems for different values of either minimum acceptable return or maximum allowable risk is said to form an “efficient frontier”, which is often depicted graphically on a plot of risk versus return. There are numerous, well known, variations of mean-variance portfolio optimization that are used for portfolio construction. These variations include methods based on utility functions in which the utility is defined as a linear combination of the expected return and predicted variance of the portfolio returns, which is the square of the predicted risk, Sharpe ratio, the ratio of annual expected return over the predicted annual risk, and value-at-risk.

Axioma, Inc. sells a commercial software product called Axioma Portfolio™ specifically designed to optimally construct a portfolio given various objectives and constraints on the final portfolio holdings. The objectives and constraints can entail combinations of return, risk, variance, tilts on scores, exposures to industries, sectors, countries, and currencies, transaction costs, and market impact functions. As particular examples, an objective may maximize the sum of the expected return (or alpha) minus the transaction costs, minus the cost of shorting, minus ticket charges, minus market impact, minus the predicted variance or risk of the portfolio. Each of these terms would have a weighting constant in front of it in the objective function, and the weighting constants would be calibrated by, say, backtests. Example constraints would include limiting the maximum sector exposure to plus or minus 10% of the benchmark sector exposures, limiting turnover to 20%, or limiting the maximum asset holding to 5%. A novel approach to portfolio construction using factor risk models is described in U.S. Pat. Nos. 7,698,202 and 8,315,936, which are incorporated by reference herein in their entirety.

There is broad consensus that the quality of a factor risk model depends on the quality of the factors, and subjective terms such as “parsimony” and “art” are frequently used to describe the research required to build a high quality factor risk model. Fundamental factor risk models need enough, well-chosen factors defined over the estimation universe that their cross sectional regressions do not have any thin industries or countries. The factors should be as linearly independent as possible, except for known dependencies such as those between industry, country, and market factors, which are normally handled using constrained or staged regressions. Factors that do not exhibit repeatable statistical significance over time should be excluded.

As a result of these stringent requirements, the factors used for a commercial factor risk model or even a custom factor risk model may be sub-optimal for the performance attribution of a particular portfolio. In performance attribution, the universe of stocks considered is likely to be different than the broad estimation universe used for risk model calibration. Industries and countries may well be empty. The signals used to construct the portfolio may be different than the factors of the factor risk model. To be sure, the quality of the performance attribution will depend on the quality of the underlying factor returns, which in turn depends on the underlying factor risk model estimation. That said, the factors of the factor risk model may be a poor match to the investment process used to construct and manage a given portfolio.

As a particular example, some practitioners prefer attribution using style exposures calibrated to Z scores within each GICS sector. The idea of normalizing a score or signal across sub-groups of assets in a factor risk model is common. Some sectors such as utilities and consumer staples are associated with low scores on style factors such as volatility and market sensitivity (beta). Hence, if those style factors are calibrated across all assets, then the Z scores for these factors for those assets in those sectors all take low values. This bias of stock scores within a sector for a style exposure may make it hard to identify if there are any persistent bets on that factor within that sector. Many practitioners also normalize their expected returns or alphas across sectors (or industries or countries) believing that enables them to construct better portfolios.

### SUMMARY OF THE INVENTION

Among its several aspects, the present invention recognizes that often, the original factors in a factor risk model are sub-optimal for computing the factor contributions and the specific contributions of a factor-based performance attribution. The present invention allows portfolio managers to split the original risk model factors into more granular factors that cover smaller subsets of the assets in the portfolio. The over-performing and under-performing exposures of split risk factors are often easier to alter in practice and can be used to improve the performance of the portfolio.

One solution to the dilemma of managing the factor requirements for estimating a risk model versus constructing performance attribution is to construct custom factor risk models, choosing the factors and estimation universe to match as closely as possible the underlying investment process. While custom risk models offer advantages, they require substantial investments of time, man-power, and computer resources, which may not be affordable for all portfolio managers. They also suffer the disadvantage that the permissible factors must satisfy the stringent requirements needed to produce a quality factor risk model.

A second approach to this dilemma is to compute factor returns “on the fly” for the factors desired for attribution, but use those factor returns solely for attribution and not for risk model estimation. That is, compute a custom set of factor returns for attribution but do not use those factor returns to construct a factor risk model. While this approach has attractive features, like custom risk models, it requires substantial human, computer, and time resources.

A third approach to this dilemma is to use linear projection to rewrite a standard risk model in terms of a set of new factors. The linear projection is constructed so that the best linear combination of the new factors is used to represent the original factors, and the risk associated with that linear combination is assigned to the new factors. As with custom risk models, in some circumstances, linear projection can be a valuable tool. However, the method suffers from at least two flaws. First, if the original factors are poorly represented by new factors, then the new factors will not have enough meaningful risk associated with them. In the extreme case where the new factors are orthogonal to all the original factors, then no risk at all is assigned to the new factors. Second, some, if not all, of the original factor exposures are altered by the projection. As a result, factors lose their intuitive interpretation. After projection, the modified value factor may be a poor representation of value.

The present invention provides an alternative approach to factor attribution that customizes the factors of a standard factor risk model “on the fly” using factor splitting. Factor splitting is a special case of linear projection that avoids the more general flaws of linear projection. This approach avoids the difficulties associated with custom risk models. The attribution begins with a standard, well calibrated factor risk model, and then allows the users to decompose existing factors, often style factors, into more granular factors that more closely fit the process used to construct the portfolio. Factor splitting allows portfolio managers to obtain custom factor-based performance attribution using: (1), sector, industry, country or region specific style factors each normalized to Z scores for the particular sector, industry, country, or region; (2), over-weight and under-weight style factors in which a factor mimicking portfolio is used to define which assets belong to which group; and (3), style factors that have been partitioned by different groups of alpha scores (high scores, medium scores, low scores). Other data besides alpha (market cap, average daily volume, specific risk, etc.) can be used as well to define the asset groups.

Because factor splitting works by partitioning, the split factors can by highly representative of any alpha or target signals employed by the portfolio manager. That is, the split factors may be readily customized to reflect any investment approach.

There is considerable appeal to using factor splitting. Different factor splits provide different perspectives (e.g., different rankings) for which factors helped and which factors hurt the portfolio performance. As illustrated here, this information can be used to construct portfolios with improved performance in historical backtests. They provide a set of previously unavailable tools for identifying unintended and poorly performing portfolio exposures, which can then be explicitly neutralized to improve performance.

When modifying risk model factors on the fly, the number of factors can increase rapidly. For example, if a factor risk model has ten style factors, then splitting each of these across all ten GICS sectors leads to a risk model and attribution with one hundred style factors. While estimating the risk associated with that many factors would almost certainly suffer from the curse of dimensionality, as addressed further below, real-world performance attribution benefits from high dimensionality. For factor splitting, dimensionality is a blessing, not a curse.

There is a school of portfolio management that trumpets the importance of systematically and rigorously neutralizing unintended bets. This idea makes intuitive sense—all bets (non-zero exposures) increase portfolio risk or tracking error, and no portfolio manager wants to needlessly take on additional risk. In practice, however, defining “unintended” can be problematic. If an unintended bet has historically added to performance, should the portfolio manager neutralize it or decide in hindsight it is intended and continue or even increase that bet in the future?

Factor splitting enables portfolio managers to easily try different factor partitions—sector specific, alpha buckets, etc.—to see which partitions uncover the most useful unintended bets, that is, bets that can be reduced or increased to improve performance. Factor splitting also quickly highlights previously unexamined factors that make significant contributions to performance.

The present invention recognizes that the factors used in a factor risk model are subject to more stringent requirements than the factors that would be optimal for a factor-based performance attribution. The present invention provides tools for rendering the sub-optimal factors of a factor risk model more optimal for performance attribution.

The present invention also recognizes that existing approaches to improve performance attribution using factor risk models do not have the granularity or simplicity of the present invention.

One goal of the present invention, then, is to describe a methodology that enables a portfolio manager to arbitrarily partition factors in an existing factor risk model into a number of different groups and produce a factor-based performance attribution using those factors without requiring any re-estimation of the factor returns or factor risk model.

Another goal is to describe an improved method for identifying the best and worst contributing factors in a performance attribution.

Another goal is to utilize the information derived from identifying the best and worst contributing factors to construct portfolios that maximize the positive contributions and minimize the negative contributions.

A more complete understanding of the present invention, as well as further features and advantages of the invention, will be apparent from the following Detailed Description and the accompanying drawings.

### BRIEF DESCRIPTION OF THE DRAWINGS

FIG. 1 shows a computer based system which may be suitably utilized to implement the present invention;

FIG. 2 illustrates summary statistics for an initial backtest for a case study illustrating various advantages of the present invention;

FIG. 3 illustrates factor-based attribution of the initial backtest using the original style factors of the Axioma risk model for the case study;

FIG. 4 illustrates performance of portfolios with between zero and five neutralized style factor exposures from the original Axioma risk model for the case study;

FIG. 5 illustrates factor-based attribution of the initial backtest using factor-mimicking-portfolio style factors, which splits each factor into overweight (FMP HI) and underweight (FMP LO) factors for the case study;

FIG. 6 illustrates performance of portfolios with between zero and four neutralized factor-mimicking-portfolio over- and under-weight style factor exposures for the case study;

FIG. 7 illustrates factor-based attribution of the initial backtest using three alpha buckets for the case study;

FIG. 8 illustrates performance of portfolios with between zero and nine neutralized alpha bucket style factor exposures for the case study;

FIG. 9 illustrates the highest and lowest factor contributions of the initial backtest using sector-specific style factors for the case study;

FIG. 10 illustrates a universe of assets together with a benchmark weight, an alpha score, and a sector and industry classification to be used in a simple factor splitting example;

FIG. 11 illustrates the original factor exposures to be used in a simple factor splitting example;

FIG. 12 illustrates the original specific risk vector to be used in a simple factor splitting example;

FIG. 13 illustrates the original factor-factor covariance matrix in percent squared units to be used in a simple factor splitting example;

FIG. 14 illustrates the original factor return vector to be used in a simple factor splitting example;

FIG. 15 illustrates the original asset-asset covariance matrix in percent squared units to be used in a simple factor splitting example;

FIG. 16 illustrates the asset sector classification, benchmark weight and Style 3 factor exposure to be used in a simple factor splitting example;

FIG. 17 illustrates the linear transformation matrix U to be used to rescale the split Style 3 by sector factor model;

FIG. 18 illustrates the modified factor return for the split Style 3 by sector factor model;

FIG. 19 illustrates the modified exposure matrix for the split Style 3 by sector factor model;

FIG. 20 illustrates the modified factor-factor covariance matrix in percent squared for the split Style 3 by sector factor model;

FIG. 21 illustrates the asset-asset covariance matrix associated in percent squared with the split Style 3 by sector factor model;

FIG. 22 illustrates a factor mimicking portfolio associated with the original Style 2 factor;

FIG. 23 illustrates the exposures of all the original factors to the original Style 2 factor mimicking portfolio;

FIG. 24 illustrates the linear transformation matrix U to be used to rescale the modified Style 2 factor split by the factor mimicking portfolio over- and under-weights;

FIG. 25 illustrates the modified factor return for the modified Style 2 factor split by the factor mimicking portfolio over- and under-weights;

FIG. 26 illustrates the modified factor exposures for the modified Style 2 factor split by the factor mimicking portfolio over- and under-weights;

FIG. 27 illustrates the modified factor-factor covariance matrix in percent squared units for the modified Style 2 factor split by the factor mimicking portfolio over- and under-weights;

FIG. 28 illustrates the resulting asset-asset covariance matrix in percent squared units for the modified Style 2 factor split by the factor mimicking portfolio over- and under-weights;

FIG. 29 illustrates a flow chart of the steps of a process in accordance with an embodiment of the present invention; and

FIG. 30 illustrates a second flow chart of the steps of a process in accordance with another embodiment of the present invention.

### DETAILED DESCRIPTION

The present invention may be suitably implemented as a computer based system, in computer software which is stored in a non-transitory manner and which may suitably reside on computer readable media, such as solid state storage devices, such as RAM, ROM, or the like, magnetic storage devices such as a hard disk or solid state drive, optical storage devices, such as CD-ROM, CD-RW, DVD, Blue Ray Disc or the like, or as methods implemented by such systems and software. The present invention may be implemented on personal computers, workstations, computer servers or mobile devices such as cell phones, tablets, IPads™, IPods™ and the like.

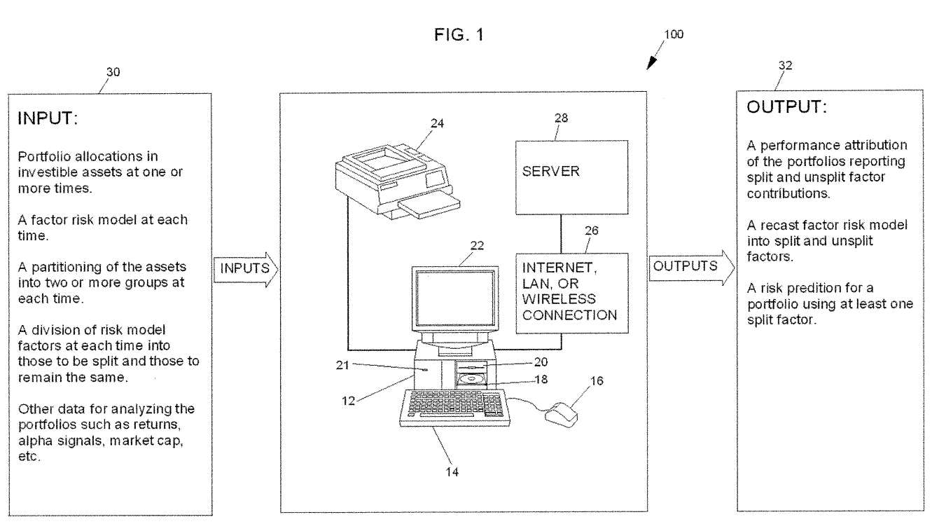

FIG. 1 shows a block diagram of a computer system 100 which may be suitably used to implement the present invention. System 100 is implemented as a computer or mobile device 12 including one or more programmed processors, such as a personal computer, workstation, or server. One likely scenario is that the system of the invention will be implemented as a personal computer or workstation which connects to a server 28 or other computer through an Internet, local area network (LAN) or wireless connection 26. In this embodiment, both the computer or mobile device 12 and server 28 run software that when executed enables the user to input instructions and calculations in accordance with the present invention as described further herein to be performed by the computer or mobile device 12, send the input for conversion to output at the server 28, and then display the output on a display, such as display 22, or print the output, using a printer, such as printer 24, connected to the computer or mobile device 12. The output could also be sent electronically through the Internet, LAN, or wireless connection 26. In another embodiment of the invention, the entire software is installed and runs on the computer or mobile device 12, and the Internet connection 26 and server 28 are not needed.

As shown in FIG. 1 and described in further detail below, the system 100 includes software that is run by the central processing unit of the computer or mobile device 12. The computer or mobile device 12 may suitably include a number of standard input and output devices, including a keyboard 14, a mouse 16, CD-ROM/CD-RW/DVD drive 18, disk drive or solid state drive 20, monitor 22, and printer 24. The computer or mobile device 12 may also have a USB connection 21 which allows external hard drives, flash drives and other devices to be connected to the computer or mobile device 12 and used when utilizing the invention. It will be appreciated, in light of the present description of the invention, that the present invention may be practiced in any of a number of different computing environments without departing from the spirit of the invention. For example, the system 100 may be implemented in a network configuration with individual workstations connected to a server. Also, other input and output devices may be used, as desired. For example, a remote user could access the server with a desktop computer, a laptop utilizing the Internet or with a wireless handheld device such as cell phones, tablets and e-readers such as an IPad™, IPhone™, IPod™, Blackberry™, Treo™, or the like.

One embodiment of the invention has been designed for use on a stand-alone personal computer running Windows 7. Another embodiment of the invention has been designed to run on a Linux-based server system. The present invention may be coded in a suitable programming language or programming environment such as Java, C++, Excel, R, Matlab, Python, etc.

According to one aspect of the invention, it is contemplated that the computer or mobile device 12 will be operated by a user in an office, business, trading floor, classroom, or home setting.

As illustrated in FIG. 1, and as described in greater detail below, the inputs 30 may suitably include portfolio allocations in investible assets at one or more times, factor risk models corresponding to each time, a partitioning of the assets into two or more groups as described further herein, a division of the risk model factors into those to be split and those to remain the same as described further herein, as well as other data used for analyzing the portfolios such as returns, alpha signals, market cap, and the like as described further herein and in the materials incorporated by reference herein. The factor risk models may suitably include fundamental factor risk models, statistical factor risk models, and macroeconomic factor risk models.

As further illustrated in FIG. 1, and as described in greater detail below, the system outputs 32 may suitably include a performance attribution of the portfolios reporting split and un-split factor contributions, a recast factor risk model into split and un-split factors, and a risk prediction for a portfolio using at last one split factor.

The output information may appear on a display screen of the monitor 22 or may also be printed out at the printer 24. The output information may also be electronically sent to an intermediary for interpretation. For example, the performance attribution results for many portfolios can be aggregated for multiple portfolio reporting. Other devices and techniques may be used to provide outputs, as desired.

A factor risk model comprises an asset return model

r=Bf+s

and a corresponding factor risk model

Q=BΣB^{T}+Δ

where

r is an N dimensional vector of asset excess returns (return above the risk free rate)

B is an N by M matrix of factor exposures (also called factor loadings)

f is an M dimensional vector of factor returns

ε is an N dimensional vector of asset specific returns (also called residual returns)

Q is an N by N matrix of asset covariances=Cov(r,r)

Σ is an M by M matrix of factor covariances=Cov(f,f)

Δ is an N by N matrix of security specific covariances=Cov(ε,ε); often, A is taken to be a diagonal matrix of security specific variances. In other words, the off-diagonal elements of A are often neglected, e.g., assumed to be vanishingly small and therefore not explicitly computed or used.

In general, the number of factors, M, is much less than the number of securities or assets, N.

For any portfolio of holdings, if the investments in each holding are represented by the column vector w, then the risk associated with that portfolio of holdings is given by

σ=\sqrt{wQw^{T}}

where σ is the risk and the superscript T indicates vector transposition. If w represents active holdings with respect to a benchmark, then the risk is the active risk or tracking error.

The covariance and variance estimates in the matrix of factor-factor covariances, Σ, and the (possibly) diagonal matrix of security specific covariances, Δ, are estimated using a set of historical estimates of factor returns and asset specific returns.

Both the covariance and variance computations may utilize techniques to improve the estimates. For example, it is common to use exponential weighting when computing the covariance and variance. This weighting is described in R. Litterman, Modern Investment Management: An Equilibrium Approach, John Wiley and Sons, Inc., Hoboken, N.J., 2003, which is incorporated by reference herein in its entirety. It is also described in R. C. Grinold, and R. N. Kahn, Active Portfolio Management: A Quantitative Approach for Providing Superior Returns and Controlling Risk, Second Edition, McGraw-Hill, New York, 2000, which is incorporated by reference herein in its entirety. U.S. Patent Application Publication No. 2004/0078319 A1 by Madhavan et al. also describes aspects of factor risk model estimation and is incorporated by reference herein in its entirety.

The covariance and variance estimates may also incorporate corrections to account for the different times at which assets are traded across the globe. For example, U.S. Pat. No. 8,533,107 describes a returns-timing correction for factor and specific returns and is incorporated by reference herein in its entirety.

The covariance and variance estimates may also incorporate corrections to make the estimates more responsive and accurate. For example, U.S. Pat. No. 8,700,516 describes a dynamic volatility correction for computing covariances and variances, and is incorporated by reference herein in its entirety.

A factor risk model may be corrected for missing factor risk by adding a new factor to a previously calibrated factor risk model. By making this new factor orthogonal to all the factors in the original risk model as well as overlapping as much as possible with the vector of portfolio holdings, the risk estimate including the new factor may make a factor risk model substantially more accurate. U.S. Pat. Nos. 7,698,202 and 8,315,936 describe such an approach to modifying factor risk models and are incorporated by reference herein in their entirety.

U.S. Patent Application Publication No. 2013/0304671 which is incorporated by reference herein in its entirety describes an improved factor risk model with two or more estimates of specific risk. Traditionally, commercial factor risk models come in three varieties: fundamental factor risk models, statistical factor risk models, and macroeconomic factor risk models.

In fundamental factor risk models, the factor exposures are defined using explicit market and security information. Typically, fundamental factor risk models include style factors which measure the exposure or loading of each security to factors such as value, growth, leverage, size, momentum, volatility, and so on. For example, Axioma's fundamental factor equity risk models include style factors that measure size, liquidity, volatility, market sensitivity, momentum, value, and growth. The exposures of style factors are often given as Z scores, in which the raw measurements of these metrics have been normalized by subtracting off the cap-weighted mean value and dividing the results by the equal-weighted standard deviation of the original measurements. See Litterman for further details. By performing this rescaling, a factor such as size (measured as market cap, with values such as billions of dollars) can be effectively compared to a factor such as volatility (measured in terms of annual volatility, which is a number less than one). Fundamental factor risk models also include categorical factors such as industries, countries, market, and currency factors. In binary models, such as those sold by Axioma, the exposure of any security is non-zero and equal to one for only one industry, one country and one currency. Other commercial factor risk model vendors sometimes spread out the exposure of an individual security across more than one categorical factor in each of these categories, with the restriction that the total exposure across each category adds up to 100%. So, for instance, General Electric stock may have non-zero exposure to both health and finance industries.

Other categorical assignments can be used as well. For instance, the global industry classification standard (GICS) taxonomy developed by MSCI and Standard & Poor's has four classification levels: Industry Sub-Groups; Industries; Industry Groups, and Sectors. Countries can be grouped by region (Americas, Europe, or Asia) or by economy (Developed or Emerging).

Once the factor exposures have been defined, the factor returns for a fundamental factor risk model are estimated using a cross-sectional regression across the security returns at any point in time.

In statistical factor risk models, the matrix of security returns across the universe of securities and back through time is analyzed to determined factors that best represent the volatility of returns. Often principal components analysis is used to determine these factors. By construction, statistical factors represent the risk of the assets well. However, since the exposures are determined mathematically, it is often difficult to develop intuition about what each statistical factor may mean in terms of traditional metrics such as size and value. Furthermore, since the factors can change from day to day, any intuition developed on one day for a particular model may not be applicable on another day.

In macroeconomic factor risk models, the factors are chosen to represent the correlation or beta of each security to a time series of macroeconomic data such as GDP, interest rates, corporate spreads, and the like.

In the present invention, any factor in any kind of factor risk model can be split. This includes fundamental factors such as style and industry factors, statistical factors, and macroeconomic factors.

There are two existing approaches that allow users to change the factors of an original factor risk model on-the-fly without changing the factor risk model predictions. That is, when using these two approaches, the exposures, B, factor returns, f, and factor-factor covariances, Σ, change, but the factor risk model, Q, and specific variance, Δ, do not.

The first existing approach is linear transformation, in which new factors are defined by linear combinations of the original factors. See S. Bell, F. Siu, and R. Stubbs, Axioma Global Model: Update, Axioma Report, Aug. 4, 2008, which is incorporated by reference herein in its entirety.

Let U be any invertible M by M matrix. Then,

r=Bf+ε=B(UU⁻¹)f+ε=(BU)(U⁻¹f)+ε

and

Q=B(UU⁻¹)Σ(UU⁻¹)B^{T}+Δ=(BU)(U⁻¹ΣU)(BU)^{T}+Δ

Therefore, the factors are altered but not the factor risk model by defining three new elements:
B′=BU
f′=U⁻¹f
Σ′=U⁻¹ΣU

As a first example, suppose it is desired to expand (rescale) the j-th factor exposure by a constant c. Let U be the diagonal matrix with the j-th diagonal element equal to c and all the other diagonal elements equal to one. Then, the linear-transformation using U performs the rescaling. That is, B′=BU, is the exposure matrix with the rescaled exposures.

As a second example, consider renormalizing the factor exposures so that they are local Z scores. In standard fundamental factor risk models, the style exposures are Z-scores calibrated to the estimation universe of the factor risk model. That is, their cap-weighted mean across the estimation universe is zero, and their equi-weighted standard deviation is one. Suppose that it is desired to change all the style exposures so that they are recalibrated as Z scores to a different universe. That is, it is desired to transform each of the style factors using the transformation

z′ⱼ=(zⱼ−mⱼ)/sⱼ

where j ranges over each of the style factors, mⱼ is the cap-weighted mean value of the original Z-scores over the new universe, and sⱼ is the equal-weighted standard deviation of the original Z-scores over the new universe. The procedure works for any constants mⱼ and sⱼ as long as the sⱼ are not zero.

This approach takes advantage of the fact that most, if not all, fundamental factor risk models have a set of factors whose exposures sum to one for non-cash assets, e.g., categorical factors. These include market factors, industry factors, country factors, and currency factors. One such set of factors is chosen, and then a U is formed such that it has all ones along the diagonal. In the j-th style column, the value “minus mⱼ” is entered in each row corresponding to, say, an industry factor. So, for example, if the factors consist of two style factors (the first and second factors) and two industry factors (the third and fourth factors), the matrix U would be

$$U = [ \begin{matrix}1 & 0 & 0 & 0 \\ 0 & 1 & 0 & 0 \\ - {m}_{1} & - {m}_{2} & 1 & 0 \\ - {m}_{1} & - {m}_{2} & 0 & 1\end{matrix} ]$$

As long as the sum of the industry exposures is one for each of the non-cash assets, this transformation will subtract off the appropriate offset from each of the asset exposures in B to each of the style factors in the modified exposure matrix BU.

Having subtracted off the offset mⱼ, the rescaling is performed using a second U matrix. The combined transformation is the product of these two matrices. Hence, for the simple four factor example, the combined transformation is

$$U = [ \begin{matrix}1 \text{/} {s}_{1} & 0 & 0 & 0 \\ 0 & 1 \text{/} {s}_{2} & 0 & 0 \\ ( - {m}_{1} \text{/} {s}_{1} ) & ( - {m}_{2} \text{/} {s}_{2} ) & 1 & 0 \\ ( - {m}_{1} \text{/} {s}_{1} ) & ( - {m}_{2} \text{/} {s}_{2} ) & 0 & 1\end{matrix} ]$$

The factor risk model predictions are unchanged regardless of whether the market, industry, country, or currency factors are used to perform the transformation. The redistribution of risk among the factors, however, is different in each case.

As a third example of linear transformation, a risk model is transformed with a market factor so that the risk in the market factor is redistributed to either the industry or country factors. The procedure is currently available in Axioma's product.

This transformation is achieved using a U matrix with ones along the diagonal, and, for the case of switching to industry factors, having the column of U associated with the market factor having values of minus one for each row corresponding to an industry factor. The inverse of this matrix changes all the minus ones to plus one. In the modified exposure matrix, BU, the exposure to the market factor is identically zero, and the risk associated with the market factor is redistributed in the modified factor-factor covariance matrix among the industry factors. After transforming to either the industry or country focus, the exposures of the market factor in the transformed risk model are all zero.

The present invention recognizes that judicious choices of the matrix U can be utilized to meaningfully alter the original factors of a factor risk model into different linear combinations of the original factors.

A second approach also exists in the prior art for altering the factors in a factor risk model without changing the factor risk model, e.g., Q. See D. Vandenbussche, Attributing Risk to User Attributes, Axioma Report, 2008, which is incorporated by reference herein in its entirety. This approach is called a linear projection approach even though projection is only a particular instance of the approach. In this approach, the existing factors of an original factor risk model are partitioned into two groups, one whose exposures will be altered, and a second set of factors that will remain unchanged. The exposure matrix is written in terms of two matrices, B₁ and B₂, such that

B=[B₁B₂]

The above partitioning is a simple partition of the original factors into two groups, group one, B₁, and group two, B₂. Each factor of the original risk model belongs to one and only one group, either B₁ or B₂, in this case. This is the definition of a partitioning as used herein, although it may be applied equally well to either factors, as is done here, or, alternatively, to assets in the set of investible assets. The corresponding partition of the factor-factor covariance matrix is

$$\sum = [ \begin{matrix}{\sum }_{11} & {\sum }_{12} \\ {\sum }_{12}^{T} & {\sum }_{22}\end{matrix} ]$$

and the corresponding factor return vector is

$$f = [ \begin{matrix}{f}_{1} \\ {f}_{2}\end{matrix} ]$$

Next, a set of K new, arbitrary factor exposures to be used is listed, denoted here as B₃. The coverage of these new factors should be the same as the coverage in the original risk model. Hence, B₁, B₂, and B₃, all have the same number of rows. However, there can be any number of new factors in B₃, each represented by one of its K columns.

The original exposures to be modified, B₁, are modeled as a linear combination of the new factors, B₃. Note that this modification is not the same as the linear transformation described above in which the new exposures, BU, are linear combinations of the original exposures. In the most general approach of the projection method, no restriction is imposed on the quality of this model, and the residual is simply directly computed

N=B₁−B₃C

If B₁ is an N by L matrix, then C is a K by L matrix of coefficients describing the linear combination of new factors. This result contrasts strongly with the linear transformation case in which U is a square, invertible M by M matrix.

The factor risk model is recast as

$${B}^{′} = [ \begin{matrix}{B}_{3} & N & {B}_{2}\end{matrix} ]$$

$${\sum }^{′} = [ \begin{matrix}C {\sum }_{11} {C}^{T} & C {\sum }_{11} & C {\sum }_{12} \\ {\sum }_{11} {C}^{T} & {\sum }_{11} & {\sum }_{12} \\ {\sum }_{12}^{T} {C}^{T} & {\sum }_{12}^{T} & {\sum }_{22}\end{matrix} ]$$

$${f}^{′} = [ \begin{matrix}C {f}_{1} \\ {f}_{1} \\ {f}_{2}\end{matrix} ]$$

Direct computation of this recast factor risk model with M+K factors has the same risk prediction (Q) as the original risk model. However, notice that although the user can specify which new factors he or she wants (B₃) and which original factors he or she wants to remain unchanged (B₂), there are additional residual factors in the recast factor risk model (N).

This approach works for any matrix C, but some choices are common and in some respects, preferred. In particular, the matrix C is often chosen so that it minimizes the magnitude or norm of N. In this case, the exposures, N, and the risk associated with them are minimized and the original risk modelled by the original factor risk model is modelled as much as possible by the new factors B₃ and the unchanged factors B₂. This is a classic minimization problem whose solution, C, is known. If the singular value decomposition of B₁ is given by

B₁=U_{SV}Σ_{SV}V_{SV}

Then, the linear projection solution is

C=B₃⁺(I−U_{SV}U_{SV}^{T})B₁

where B₃⁺ is the pseudo-inverse of B₃. Alternatively, various linear regression approaches—weight least squares, robust regression, etc., could also be used to construct the coefficient matrix C. The linear projection solution for C is referred to herein as the linear projection approach. However, as previously stated, any appropriately dimensioned matrix C may be used. Note as well that some of the columns of N may be identically zero, indicating that the corresponding columns in B₁ can be exactly modelled using the columns of B₃. The factors corresponding to vanishing columns in N can be omitted from the recast factor risk model. This insight is an important aspect of the present invention as addressed further below.

The basics of factor-based performance attribution are next reviewed, since factor-based performance attribution is one of the primary motivators for altering the original factors of a factor risk model without changing the risk model predictions.

Performance attribution is a tool that explains the realized performance of a set of historical portfolios using a set of explicatory factors. The factors often are those employed in a factor risk model. Attribution identifies the sources of return, often termed contributions, that, when added together, describe the portfolio performance as a whole. Performance attribution can be performed on either the returns of the total portfolio, w, or the returns of the active portfolio, w−w_{b}, where w and w_{b} are N dimensional vectors representing the investment weights or allocations for the portfolio (w) and the benchmark (w_{b}), if any benchmark is specified.

For an active portfolio, at each time period p,

$$Portfolio Contribution = {R}^{( p )} = {\sum }_{i = 1}^{N} ( {w}_{( i )}^{( p )} - {w}_{( b i )}^{( p )} ) {r}_{i}^{( p )}$$

$$Portfolio Factor Contribution = {FR}^{( p )} = {\sum }_{i = 1}^{N} {\sum }_{j = 1}^{M} ( {w}_{( i )}^{( p )} - {w}_{( b i )}^{( p )} ) {B}_{( i j )}^{( p )} {f}_{( j )}^{( p )}$$

$$Portfolio Specific Contribution = {SR}^{( p )} = {R}^{( p )} - {FR}^{( p )}$$

are computed where r₍ⱼ₎^{(p)} is the asset return of the i-th asset at time p and f₍ⱼ₎^{(p)} is the factor return of the j-th factor at time p. The equation for the active exposure of the j-th factor at time (p) is

$$Portfolio Factor Exposure = {EXP}_{j}^{( p )} = {\sum }_{i = 1}^{N} ( {w}_{( i )}^{( p )} - {w}_{( b i )}^{( p )} ) {B}_{( i j )}^{( p )}$$

In traditional performance attribution, period contributions are compounded and linked together so that their aggregate contributions sum to the total active return of the portfolio. See Litterman for details of several methods for compounding and linking contributions including the methodology proposed by the Frank Russell Company and the methodology proposed by Mirabelli.

As a particular example, in the method proposed by the Frank Russell Company, the portfolio return and one-period sources of return are computed in terms of percent returns. Then, each one-period percent return is multiplied by the ratio of the portfolio log-return to the percent return for that period. Then, the resulting returns are converted a second time back into percent returns by multiplying by the ratio of the full period percent return to the full period log return. This approach achieves the important attribution characteristic of having multi-period sources of return that are additive. Of course, these transformations perturb the realized risk of the contributions since the original period contributions are perturbed. In general, the modifications derived from linking for both contributions and risk contributions are small.

By restricting the values of j in the equation for the Portfolio Factor Contribution to a subset of the M factors, the contribution of a factor or group of factors towards the overall performance can be computed. For example, the style contribution is computed by including only those j's corresponding to style factors.

If a portfolio has been constructed to maximize its exposure to an alpha signal, then that strong exposure to alpha translates into a strong exposure to the risk model factors that best describe the alpha signal. Ideally, one would expect large positive contributions from those factors that describe the alpha signal well and relatively smaller contributions from the other factors and the specific return contribution. The equation for the active exposure to an alpha signal, α, at time (p) is

$$Portfolio Alpha Exposure = {ALPHA\_EXP}_{j}^{( p )} = {\sum }_{i = 1}^{N} ( {w}_{( i )}^{( p )} - {w}_{( b i )}^{( p )} ) {α}_{( i )}^{( p )}$$

where α is an N dimensional vector of alpha signals.

As a general rule of thumb, portfolio managers try to reduce exposure to unintentional exposures. All non-zero exposures add to the risk of the portfolio (either total risk or active risk or tracking error relative to a benchmark), and, as a rule, portfolio managers should only take on risk with their portfolio allocations if they believe that such investments will produce a positive return.

There are, however, several practical difficulties with the otherwise self-evident goal of reducing unintentional exposures. First, if an erstwhile unintentional bet has been producing positive contributions to the portfolio performance, a portfolio manager may decide this exposure is actually intentional and keep it or possibly increase it rather than trying to reduce its exposure. Second, when using the original factors of a factor risk model, the exposures to the factor may be so broad that it may be impractical to reduce a particular exposure since it might entail trading too many securities thereby incurring excessive trading costs. Furthermore, because original risk model factors are broad by construction so that their factor returns can be reliably estimated, reducing the exposure to one factor in a portfolio often has unexpected effects on the other factors. As the particular examples provided herein illustrate, better portfolio performance can be obtained by using factor-based attribution with split factors. Split factors are more granular and affect a smaller subset of the assets in a portfolio. As a result, reducing an unintended exposure to a split factor often requires far less trading and transaction costs than reducing an unintended exposure to an original risk model factor. Furthermore, as illustrated herein, reducing the exposure to poorly performing split factors can substantially improve performance of a portfolio in historical backtests.

Having reviewed the prior art for factor risk models, types of factors in factor risk models, existing approaches for changing factors of a fully calibrated factor risk model without altering the risk predictions, and factor-based performance attribution, aspects of the present invention and how it advantageously builds and improves thereon are addressed in detail.

A goal of the present invention is to recast an original factor risk model into a new set of factors whose performance attribution will be more useful for portfolio managers analyzing the performance of historical portfolios and constructing new portfolios of investments. The prior art includes two existing approaches to recasting original risk model factors, namely, linear transformation and linear projection. In linear transformation, the new factor exposures are defined as linear combinations of the original factors. This approach greatly restricts the kinds of new factors that can be formed. For example, in Axioma's U.S. equity fundamental factor risk model, there are 78 factors that cover a universe of over 9,000 assets. Linear transformation thereof is restricted to factors spanning the original 78 dimensions of this 9,000 dimensional linear space. In linear projection, the second existing method, the new factors, B₃, can be arbitrarily specified. They do not have to be linear combinations of the original factors. However, there is an explicit trade-off. The greater the extent to which the new factors, B₃, cannot be used to model the original factors, then the larger the magnitude of the residual matrix, N, and, more likely than not, the larger the factor contributions derived from the residual factors, N, will be. Since the original goal of introducing the new exposures, B₃, to the risk model was to explain performance using these factors, the presence of a residual N with significant risk associated with its factors is detrimental to this goal.

The present invention recognizes that it is advantageous to utilize a factor transformation for recasting an original factor risk model in terms of a set of new factor exposures such that: (a), the new factors are not a linear combination of the original factors; (b), the original factors are an exact linear combination of the new factors, so that the residual matrix N is identically zero; and (c), the vanishing residual factors are omitted from the recast risk model, so that the recast risk model only contains the specified new factors, B₃, and the specified subset of original factors that was to remain unchanged, B₂. The above approach is a particular case of linear projection transformation. However, as will be illustrated, it is a particularly powerful instance that has not been previously identified, explained, or presented.

In factor splitting in accordance with the present invention, one of the original factors is partitioned into a set of K factors that sum to the original factor and are non-zero for each asset in only one of the K factors. For example, in the case of splitting a factor, f₁, into three partitions:

$${f}_{1} = [ \begin{matrix}a \\ 0 \\ 0\end{matrix} ] + [ \begin{matrix}0 \\ b \\ 0\end{matrix} ] + [ \begin{matrix}0 \\ 0 \\ c\end{matrix} ]$$

Any factor can be split or partitioned into two or more factors in this manner. Each asset has its original exposure to the factor listed in one of the split or partitioned factors while the exposure of that asset in all the other partitions is zero. That is, the exposure for each asset is non-zero for one and only one of the split or partitioned factors. A great advantage of factor splitting as defined herein is that the matrix of coefficients, C, for the linear projection matrix is a vector of all ones. That is, when:

$${B}_{1} = {f}_{1}$$

$${B}_{3} = [ \begin{matrix}a & 0 & 0 \\ 0 & b & 0 \\ 0 & 0 & c\end{matrix} ]$$

$$C = [ \begin{matrix}1 \\ 1 \\ 1\end{matrix} ]$$

then the residual matrix, N, is identically zero, e.g., N=B₁−B₃ C=0, and can be explicitly dropped from the recast factor risk model. In the more general case where more than one factor is considered, the coefficient matrix C is a matrix of zeros and one. Once the partitioning of one or more factors has been determined, the coefficient matrix C can be written down by inspection, with minimal and perhaps no computation. It is, indeed, a very special case of linear projection. Returning to the particular example in which f₁ is split as shown above, using the linear projection approach, the modified exposure matrix is

B′=[B₃B₂]

where B₂ represents all the original risk model factors except f₁; the modified factor-factor covariance matrix is

$${\sum }^{′} = [ \begin{matrix}C {\sum }_{11} {C}^{T} & C {\sum }_{12} \\ {\sum }_{12}^{T} {C}^{T} & {\sum }_{22}\end{matrix} ]$$

Since Σ₁₁=σ₁, the variance of the factor f₁, the first three columns of the modified factor-factor covariance matrix are identical, as are the first three rows. So, even though there are M+2 factors in the recast factor risk model, there are two new vanishing eigenvalues for the recast factor-factor covariance matrix. The modified factor return is

$${f}^{′} = [ \begin{matrix}C {f}_{1} \\ {f}_{2}\end{matrix} ] = [ \begin{matrix}{f}_{1} \\ {f}_{1} \\ {f}_{1} \\ {f}_{2}\end{matrix} ]$$

Although factor-splitting is illustrated herein by re-ordering the assets so that the non-zero exposures α of f₁ are the first subset of assets, b is the second subset of assets, and c is the third subset of assets, it is not necessary to reorder them in practice. One can simply keep track of which assets are associated with which partition.

Although the present invention has been illustrated in the context of a special case of linear projection in which N, the residual exposure matrix, is identically zero, to the inventor's knowledge, this particular special case has not been previously suggested, considered, tried, or evaluated in the presently described context. The case of factor splitting has numerous special properties that differentiate it from the prior art, especially the linear projection technique as applied to contexts different from factor splitting, such as rewriting a set of factors in terms of a different set of factors. First, because splitting as described herein is so simple, no additional math is needed to compute C or N. In the existing prior art, such as linear projection to rewrite one set of factors in terms of a different set of factors as practiced by the Axioma Portfolio™ software presently sold by Axioma, regardless of what new factor exposures are selected, a routine is computed to compute C, the projection of those new factors onto the original factors. In the present invention, the projection matrix is simply a matrix with ones and zeros. So factor splitting differs from the prior art in that the formal linear projection formulation can be written down immediately by inspection or utilizing only a small amount of computational resources, as C has only integer values, and N=0. In fact, the original invention was conceived without using linear projection and was only recast into that format after the fact. As such, the solution for C advantageously depends only on the asset partition.

Researchers who have used Axioma's existing linear projection are believed to have always used the tool to try to rewrite one set of factors from a first factor risk model in terms of a different set of factors that they consider more intuitive. For example, some of Axioma's clients wish to replace some of Axioma's style factors for value and growth with similar factors that are defined and constructed using an alternative method. That is, they want to change Axioma's value and growth factors into their own value and growth factors. Or, alternatively, a user of a statistical factor risk model may wish to change the statistical factors of that model which have limited intuition into a set of factors with better intuitive properties such as industries or style factors. Note that in both of these cases, the least squares solution for the projection, e.g., C and N, will depend on both the original and new factor exposures making that analysis computationally complicated, and N will almost surely be non-zero.

In one aspect of the present invention, the solution for C and N will depend only on the asset partition and N will always be zero. This is a key simplification. It gives the user great flexibility to define new split factors in a wide range of existing factors, such as industry, country, alpha, size, value, growth, etc. It allows the split factors to have as few or as many assets as the user desires, and, as previously noted, because N=0, there is no residual risk and the factor model has only the factors the user wants.

When factor splitting is used repeatedly, for example, across sectors, countries, or the like, the number of factors can increase quickly. However, as long as the split factor exposures retain the vanishing exposures of the original partition, then the number of non-zero exposures for each asset does not change. If this sparsity of the exposure matrix is maintained and utilized, the computational expense of computing risk with hundreds of split factors is substantially the same as that of the original un-split risk model. If, however, the vanishing, split exposures are adjusted so that they are no longer zero (say, by making them local Z scores and subtracting off an offset m from all the assets), then the exposure matrix will no longer be sparse and the computational expense of using the factor risk model may increase when factors are split.

Of course, not all components of the split factor risk model are always needed. For portfolio construction, if the constraints are only applied to the new exposures, all that is needed are the original risk model and the new exposures. There is no need to compute the fully modified factor risk model. For performance attribution, all that is usually needed are the modified exposures and factor returns. The modified factor-factor covariance matrix is rarely needed in practice for back-testing and performance attribution. It can, however, be useful for point-in-time risk analysis.

In particular, for performance attribution, it is often advantageous to compute the modified factor exposures and modified factor returns “on-the-fly” rather than computing them directly, saving the result, and then using those modified matrices to compute the partitioned, and non-partitioned factor contributions. That is, when computing factor contributions, a routine can use a procedure of several steps in which, first, a factor is selected, and second, a partition for that factor, if any, is found. Then, if that factor is not to be partitioned factor contribution is computed and assigned directly. If, however, the factor is to be partitioned, the factor contribution from each asset can be added to the appropriate partitioned, factor contribution without explicitly computing either a modified factor exposure matrix or modified vector of factor returns. Such a procedure can be extremely efficient as it utilizes the sparsity of the partitioned factor exposures to substantially reduce the computational effort. In particular, the vanishing elements of the modified factor exposure matrix are not computed or stored, and their contribution to each factor contribution, which vanish identically, is not computed. Such efficient implementations of matrix computations involving sparse matrices are well known and used extensively in practice, especially for iterative matrix computations. See L. N. Trefethen and D. Bau, III, Numerical Linear Algebra, Society for Industrial and Applied Mathematics (SIAM), Philadelphia, 1997, which is incorporated by reference herein in its entirety.

Next, several advantageous instances of factor splitting are addressed in further detail below.

First, an original factor risk model is split so that all the style exposures are recalibrated as sector-specific Z scores. That is, for a factor such as value, ten new factors are constructed, one for each sector, which are non-zero only for assets within each sector, and whose cap-weighted mean for non-zero exposure is zero and equi-weighted standard deviation for non-zero exposures is one. This splitting is accomplished by first splitting each style factor so that it is partitioned across each sector. Since there are ten sectors, if there are J style factors, the original style factors will be partitioned into 10 J new factors. The coefficient matrix C is a 10 J by J matrix, with the first 10 elements of the first column as ones, the second ten elements of column two as ones, etc. In other words, C is a matrix of ones and zeros. The local Z scores are then created using the linear transformation approach U already described. This transformation can be performed using the industry factors, since they align with each sector. The two transformations can be combined using modified coefficient matrix C′=C U although this coefficient matrix will likely have elements that are different from zero and one.

Second, consider the exposures defined by a factor mimicking portfolio (FMP). For any exposure matrix, define the FMP of the j-th factor as the j-th column of the matrix

F=WB(B^{T}WB)⁺

where W is a diagonal matrix of asset weights and the pseudo-inverse is taken, since the matrix to be inverted is often singular. Common choices for the asset weights are market capitalization and asset specific risk. The properties of an FMP are that it has unit exposure to the designated factor and vanishing exposure to all other factors in the exposure matrix.

An FMP partitions a factor into two partitions, one with positive FMP exposures, the other with negative FMP exposures. This FMP partition separates the original risk model factors into over-weight and under-weight partitions.

With an arbitrary partition such as this, a question arises as to the best method to re-normalize the split factor exposures. There are at least three different options.

First, the split FMP factors could be left as is—that is, with the values from the original risk model. It is unlikely, however, that the (cap-weighted) mean and standard deviation of each split factor would have any particular values. Therefore any intuition with these factors that comes from using Z scores would be lost.

Second, each of the split FMP factors could be converted into local Z scores as described above. However, this would involve subtracting off the (cap-weighted) mean value from the split exposure from all the assets, including those that were zero after splitting (since the partition does not necessarily align with the industry exposures, as it did in the case of sector/industry/country/region/currency Z scores). The local Z scores would therefore not preserve the sparsity of the original split. Consequently, this approach would potentially increase the computational effort associated with the risk model as well as losing the intuition of thinking of the over-weight and under-weight exposures as non-overlapping exposures.

Third, a compromise renormalization can be performed in which each FMP factor is rescaled to have a standard deviation of one but no offset of the mean is performed (i.e., mⱼ=0). This approach advantageously preserves sparsity and the intuition of non-overlapping overweight and underweight exposures. In the case of benchmark relative Z scores, this approach is equivalent to using a local Z score. Consequently, this is the approach used in the examples presented here, and is a preferred embodiment of the present invention

As a third example of factor splitting, assume that the portfolio manager has a vector of expected returns or alphas, α, whose net portfolio exposures he or she wishes to maximize when constructing the portfolio.

If the alphas naturally divide into a set of positive and negative values, one could partition each of the style factors as was done above for the FMP Z scores to develop over- and under-weight style factors with respect to alpha.

More generally, the alpha scores can be partitioned into K buckets, ranging from low to high alpha scores. Then, each of these buckets can be used to partition the style factors.

In addition to using the alpha scores to partition the style factors, almost any vector can be used to do so, including market cap, predicted or realized risk (total risk, specific risk), ADV, and the like. The buckets need not have the same number of assets. So, for market cap, a super-large cap bucket might have 50 to 100 assets in it, while a small cap bucket could have 2000. As illustrated in the examples to follow, this form of factor splitting can be particularly effective.

An important characteristic of the splits considered here is that they are all derived from a partition of one or more original factors across a subset of assets. The transformations described allow the original factor risk model to be recast so its risk predictions remain unchanged. However, the factor contribution of the j-th factor for the L-th asset partition can be computed directly without recasting the risk model, using the formula

Factor Contribution for j-th factor, L-th asset partition

$${FR}_{( jL )}^{( p )} = {\sum }_{i ∈ L} ( {w}_{( i )}^{( p )} - {w}_{( b i )}^{( p )} ) {B}_{( i j )}^{( p )} {f}_{( j )}^{( p )}$$

This formula indicates that performance attribution using split factors need not formally recast the original factor risk model because the split factor contributions can be computed directly from the asset partitions as long as the bookkeeping is properly handled to insure each partitioned factor's contribution is properly accounted for. This, of course, is one of the advantages of the sparsity possible with factor splitting.

Some combinations of risk model factors are closely associated with asset partitions. For example, a binary industry factor only includes a subset of the assets, and the set of all industry factors is a partition of the assets covered. Combinations of industry factors can be used to partition the assets covered into sectors. The idea of using categorical factors such as industry and country factors to create partitions of the asset universe is not new. Indeed, Axioma's standard performance attribution product currently rolls up industry contributions into sector contributions by adding together the appropriate industry contributions. However, one idea missing from the prior art is the idea of using an arbitrary asset partition to split one or more individual factors while keeping the other factors fixed.

Next, factor splitting is illustrated using a historical backtest case study. The historical portfolios are rebalanced monthly from Dec. 31, 1999 to Dec. 31, 2013 (169 monthly rebalances). At each rebalance, the portfolio only holds constituents of the Russell 1000 index of large cap US equities. Axioma's medium horizon, fundamental factor US equity factor risk model (AXUS3-MR) is used to estimate the tracking error between the portfolio and the Russell 1000 benchmark, and at each rebalance, the tracking error can be at most 1.5% annual volatility. The expected return is modelled using the average of two of the style factors in the original factor risk model, the medium-term momentum and the value factors, given as original (e.g., risk model) Z-scores. The portfolio's exposure to the alpha signal is maximized at each rebalance, subject to the tracking error constraint as well as a maximum, active asset weight of 1%. The round-trip turnover is limited to 20% at each rebalance, but this constraint is placed in Axioma's constraint hierarchy, so may be violated at any rebalance if necessary to avoid an infeasible portfolio construction problem.

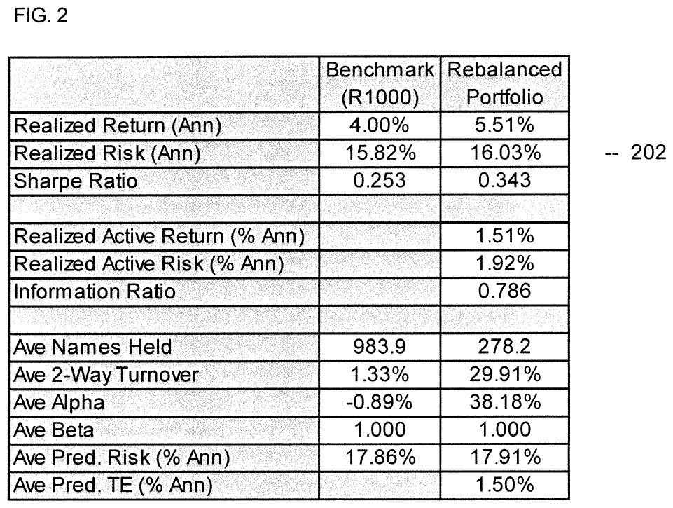

Table 202 in FIG. 2 shows a summary of the results of this backtest. The active return of the portfolio is 1.51%, leading to an information ratio of 0.786. The average turnover is almost 30%, so the turnover constraint is violated at times.

The initial backtest shows the portfolio already performs well. Can it do even better? To answer this question, a series of factor-based performance attributions were performed using the Axioma risk model.

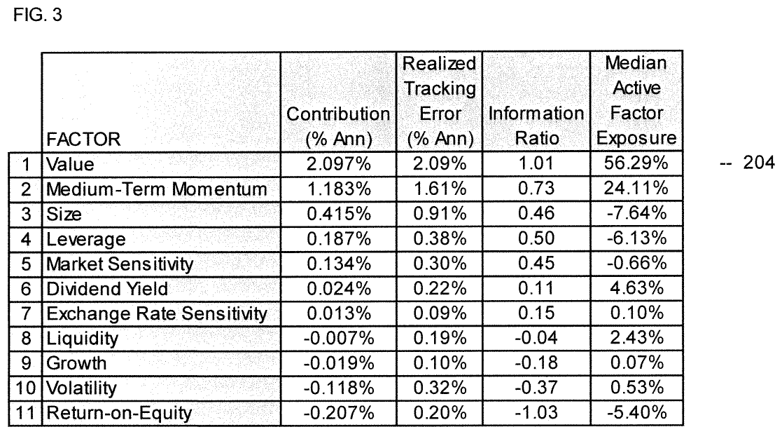

For the first performance attribution, the original factors of the Axioma factor risk model are used. Table 204 in FIG. 3 shows the factor-based attribution of the initial backtest using the original style factors of the Axioma risk model. Contributions for the industry and market factors were computed but are not presented here.

The eleven style factors were sorted in order of decreasing contribution. Value and medium-term momentum are the two largest contributors and have the largest median active exposures, as would be expected since the alpha signal is a linear combination of these two factors. Four factors—liquidity, growth, volatility, and return-on-equity—have negative contributions to the portfolio performance. Their median exposures are not particularly large, ranging from −5.04% to 2.43% (measured as a Z score). Nevertheless, one might wonder if neutralizing these under-performing style bets would improve historical performance.

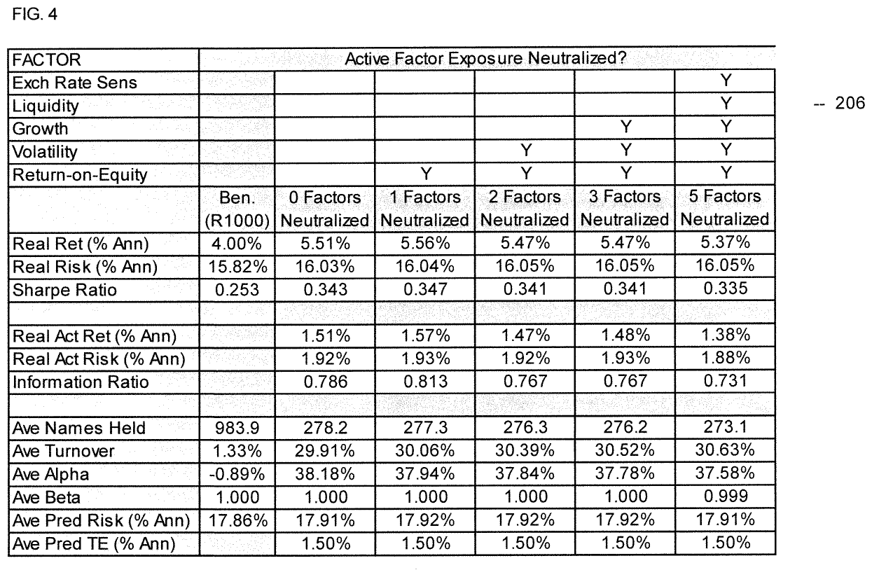

Table 206 in FIG. 4 shows the performance statistics of backtested portfolios neutralizing between zero and five different style factors from the original Axioma risk model. The factors are chosen starting with the factor with the largest negative contribution to performance (return-on-equity) and then repeatedly adding the next worst. This particular order may not be optimal, but it suffices for purposes of the present illustration.

Neutralizing the worst factor—return-on-equity—increases performance modestly, adding 6 bps to the return, and increasing the information ratio from 0.786 to 0.813. Neutralizing any more factors degrades performance relative to the initial backtest. This illustrates the limitations of using the broad original factors for factor attribution. The results obtained may be too broad to identify useful exposures to improve performance when neutralized.

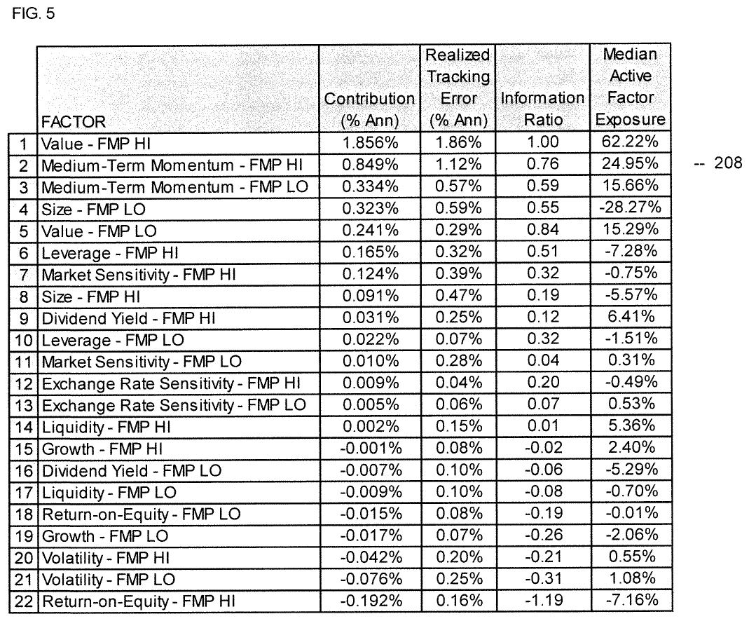

Using factor splitting in accordance with the present invention, more granular versions of the original factors can be produced which can potentially identify more profitable factor bets to neutralize than those shown in Table 206. Table 208 in FIG. 5 presents factor-based attribution of the initial backtest using a factor mimicking portfolio (FMP) partition of the original style factors. This partitioning splits each style factor into overweight and underweight factors, so there are now twice as many factors. The four medium-term momentum and value factors are near the top of the table. However, it can be seen that the size-FMP LO factor actually out-performs the value-FMP LO factor. It also has a fairly sizable median active exposure. So already, by partitioning the original style factors, a particular factor has been identified that contributed notably to performance. In the previous analysis, size was the third highest contributor of the original factors but its exposure was not notably large.

Once again, a series of backtests is performed neutralizing the factors at the bottom of Table 208 to see if performance can be improved. Once again, large gains in performance are not expected as the median exposures of these factors are already quite small. The question is whether or not rigorous treatment of these exposures improves performance.

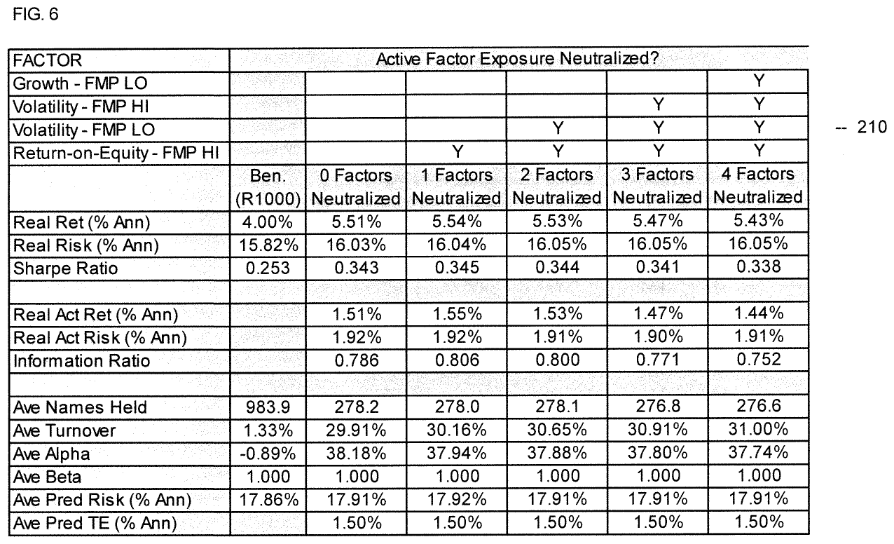

Table 210 in FIG. 6 shows the results of neutralizing the worst one to four FMP style factors (return-on-equity—FMP HI, volatility—FMP LO, volatility—FMP HI, and growth—FMP LO). The highest returns occur neutralizing the worst and second worst factors, but the increases are quite modest. So, even though a richer vein of potentially exploitable unintended factor exposures has been uncovered, a way of splitting the factors for this particular case study that notably improves performance has not been found yet.

Next, the granularity of the factors is increased by creating three alpha buckets, Bucket 1 with the lowest third of alpha scores, bucket 2 with the middle third, and bucket 3 with the highest third. It will be recognized any number of buckets can be used. Three are chosen here for purposes of illustration.

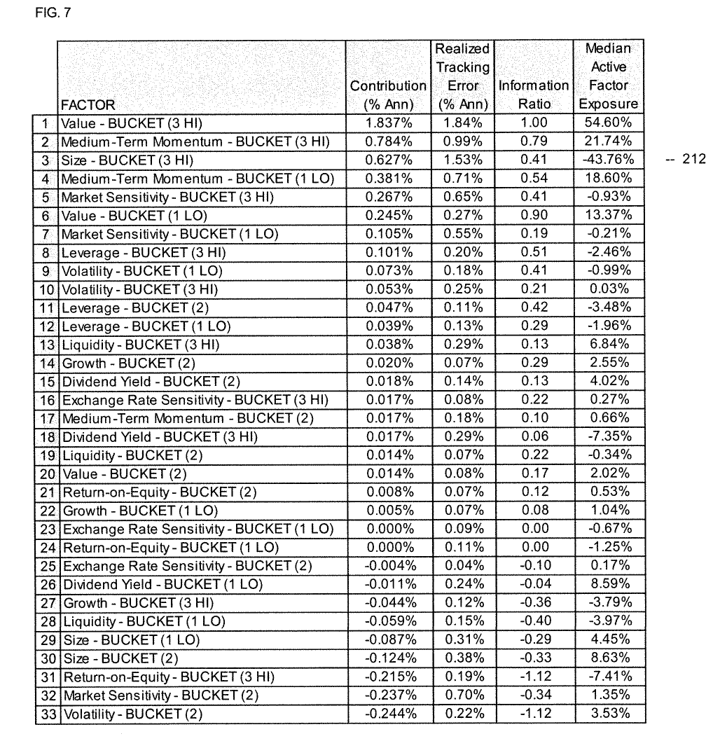

Table 212 in FIG. 7 shows the factor-based attribution of the 33 style factors using three alpha buckets.

Once again, four of the six medium-term momentum and value factors are near the top of the table. However, now two buckets do not make significant contributions: medium-term momentum—BUCKET (2) and value—BUCKET (2). In other words, these two middle buckets, with neither high nor low alpha scores, contribute little to the performance. They also exhibit fairly modest median active exposures. These are not surprising results, but it is helpful to have such results quantitatively documented.

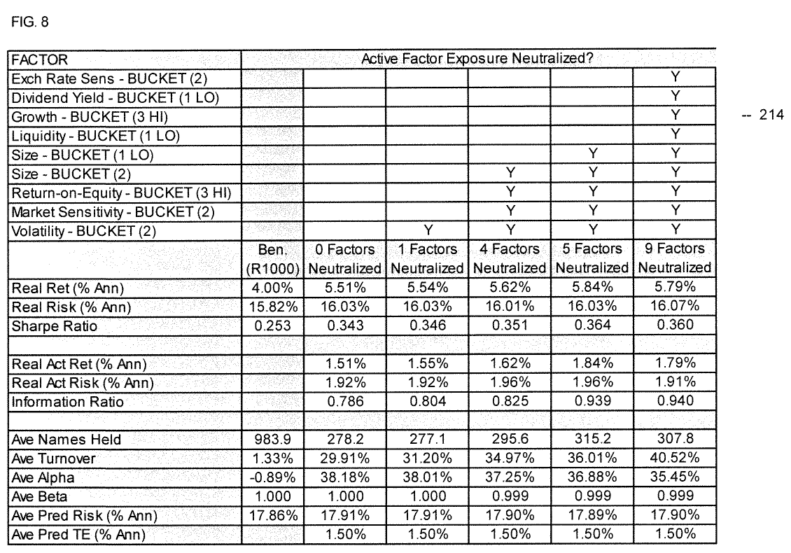

Table 214 in FIG. 8 shows the performance obtained by selectively neutralizing the worst contributing factors. In this case, increases are obtained in performance (return, active return, and information ratio) that are both positive and meaningful. 33 bps of performance are added while keeping the predicted and realized tracking errors essentially unchanged. The turnover also increased, so there are potential liquidity issues associated with neutralizing these factors (likely driven by stocks entering and exiting the middle buckets). Nevertheless, the ease with which this analysis and results are obtained make them intriguing.

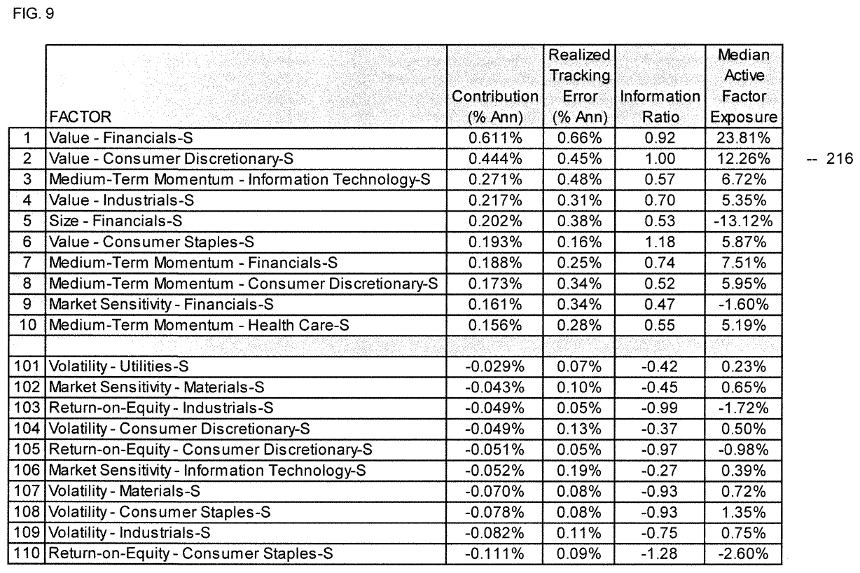

Finally, for the sake of completeness, results are presented for sector specific style factors. Table 216 in FIG. 9 shows the highest and lowest of the 110 style factors (eleven original factors split across ten GICS sectors).

Once again, it is seen that many of the highest contributions are factors derived from the alpha signal, value and medium-term momentum. But, it is also seen that large contributions come from “Size—Financials-S” and “Market Sensitivity—Financials-S”, which quickly red-flags the performance of the financials sector as a key contributor to the overall performance of this portfolio.

When the bottom one to ten sector-specific style factors are neutralized, the information ratio of the backtest increases from 0.786 to 0.806 while increasing the return by 5 bps. Overall, neutralizing the under-performing sector-specific style factors improves performance for this particular example modestly.

A second case study was performed in which the alpha score approach just used (an average of medium-term momentum and value) was converted into sector-neutral scores. The initial backtest in this case was notably better than the case just presented. The realized active return was 1.87% with an information ratio of 0.99. However, the improvements derived from neutralizing the lowest performing factors were similar. For the case of the original factors, 4 bps could be added; for the FMP factors, 6 bps; for three alpha bucket factors, 56 bps, and for sector Z scores, 9 bps. As with the first case study, using three alpha buckets improved the performance the most.

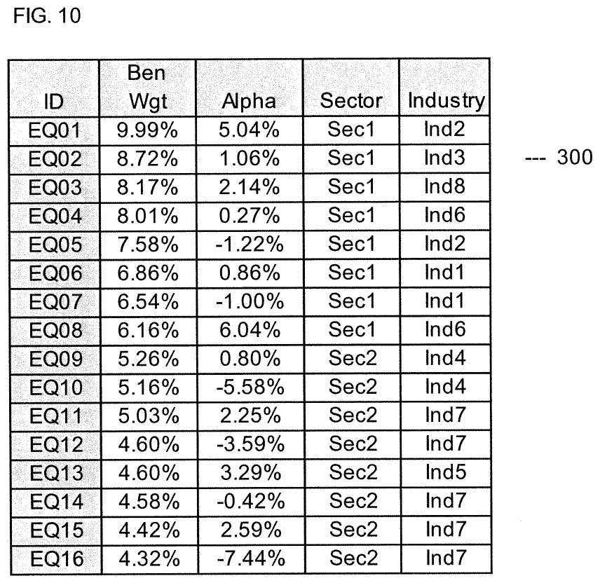

Next, the present invention is illustrated using a simple, explicit model. Table 300 in FIG. 10 shows data for a universe of 16 assets. The assets are named EQ01, EQ02, . . . , EQ16, and could represent equities, or other investment opportunities. Each of the 16 assets is assigned a benchmark weight, and alpha score, a sector classification, and an industry classification, each of which is indicated in table 300. The sum of the weights is 100%. The assets are classified into two sectors, “Sec1” and “Sec2”, and into eight industries, labelled “Ind1”, “Ind2”, “Ind8”.

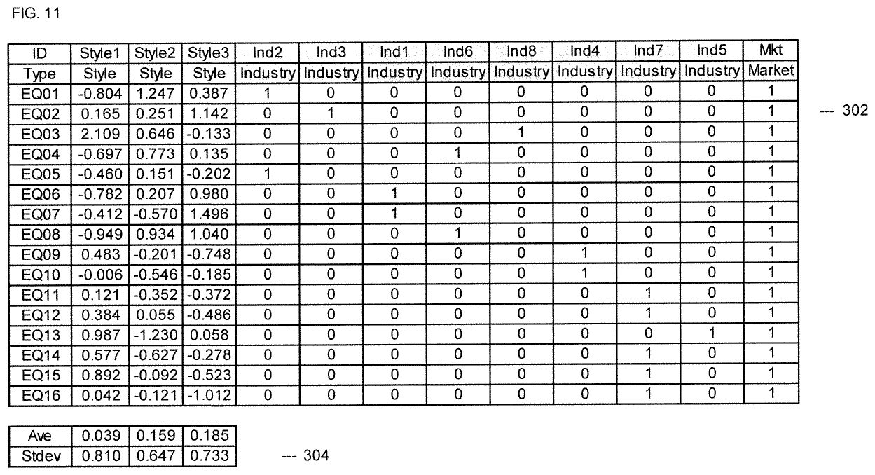

An original factor risk model is associated with the investment universe of table 300. Table 302 in FIG. 11 illustrates the original exposure matrix for the 16 assets. The factor risk model has 12 factors: three style factors, labelled “Style1”, “Style2”, and “Style3”; eight industry factors, which are binary; and one market factor named “Mkt”. Table 304 in FIG. 11 shows the cap-weighted average (labelled “Ave”) and equi-weighted standard deviation (labelled “Stdev”) for the three style factors. In this original factor risk model, these are not Z scores, in that the cap-weighted average is not exactly zero and the equi-weighted standard deviation is not one. These original exposures could be altered using a linear transformation matrix U to make them into Z scores if desired

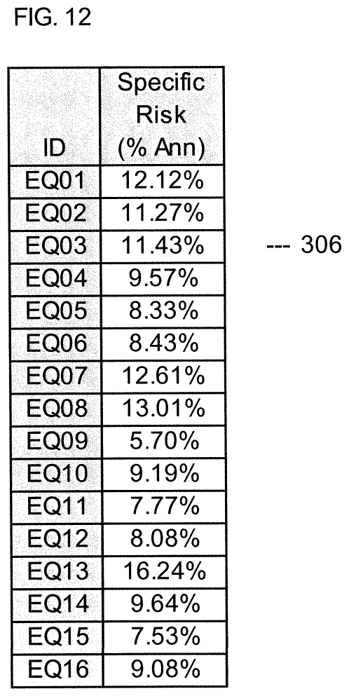

Table 306 in FIG. 12 gives the original specific risk for each of the sixteen assets, measured in percent annual volatility. This part of the factor risk model is not altered by any of the transformations or modifications considered here, but it is required in order to compute the asset-asset covariance matrix associated with the original factor risk model.

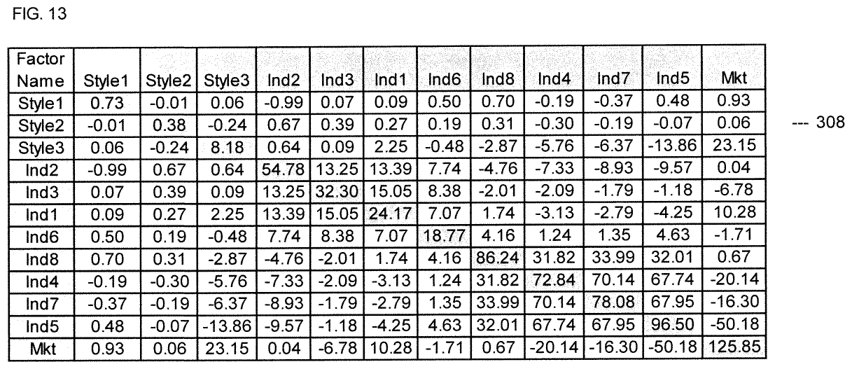

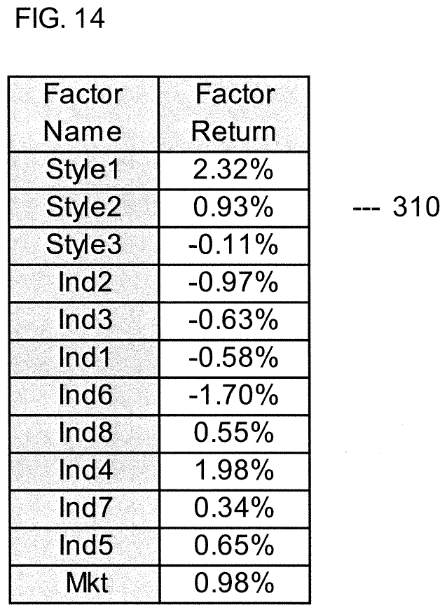

Table 308 in FIG. 13 gives the original factor-factor covariance matrix for the twelve original factors. The values are given in units of percent annual variance squared for simplicity. Table 310 in FIG. 14 gives the original factor return, in units of percent, for the twelve factors.

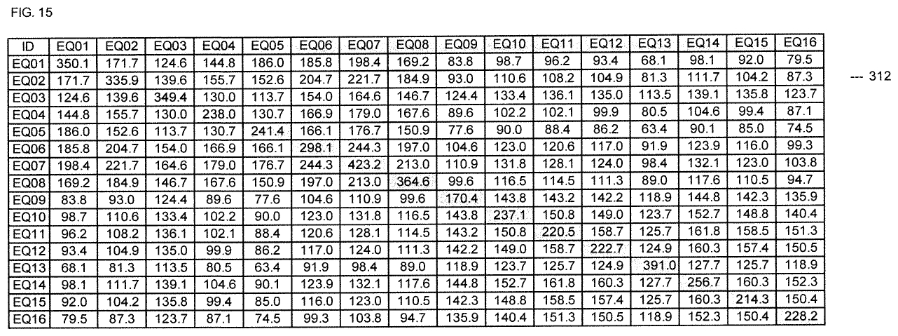

Table 312 in FIG. 15 gives the asset-asset covariance matrix for the original factor risk model, written in units of percent annual variance squared. This matrix remains unchanged for all the transformations considered here. It will be re-computed below several times to illustrate that it does not change from the original values shown in table 312.

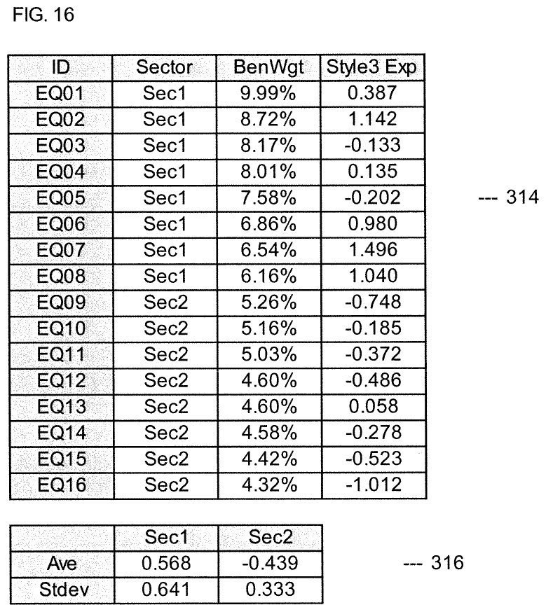

Table 314 in FIG. 16 lists the 16 assets, their corresponding sector classification, benchmark weight, and exposure to the Style3 factor. Table 316 gives the cap weighted average and equi-weighted standard deviation of the Style3 factor exposures broken down into each of the two sectors, Sec1 and Sec2.

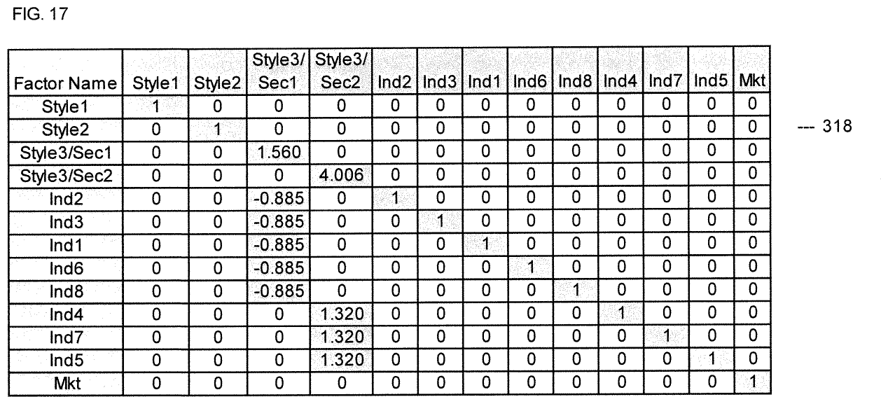

For the first illustrative factor splitting example, the original Style3 factor is split into two Sector Style3 factors, each with a renormalized Z score exposure. The original Style3 factor is split into two factors, “Style3/Sec1” and “Style3/Sec2”. All the other factors remain unchanged. Table 318 in FIG. 17 gives the linear transformation matrix U required to convert the exposures of each of these two new factors into sector Z scores. As can be seen, an offset is subtracted from each industry corresponding to each sector, and the exposures are rescaled by the diagonal value.

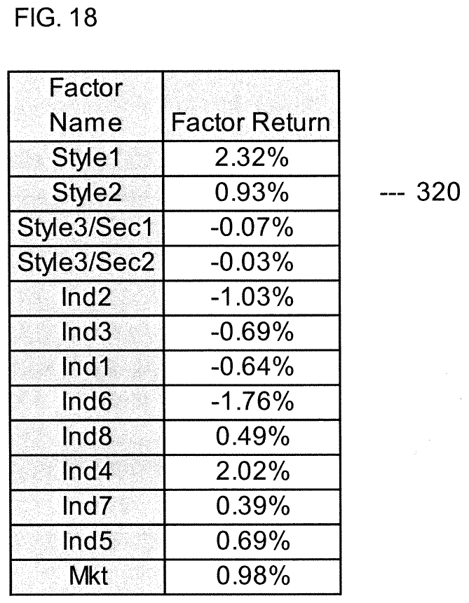

Table 320 in FIG. 18 gives the modified factor return associated with the new Style3 sector risk model. As can be seen, the factor returns of all the original factors are unchanged.

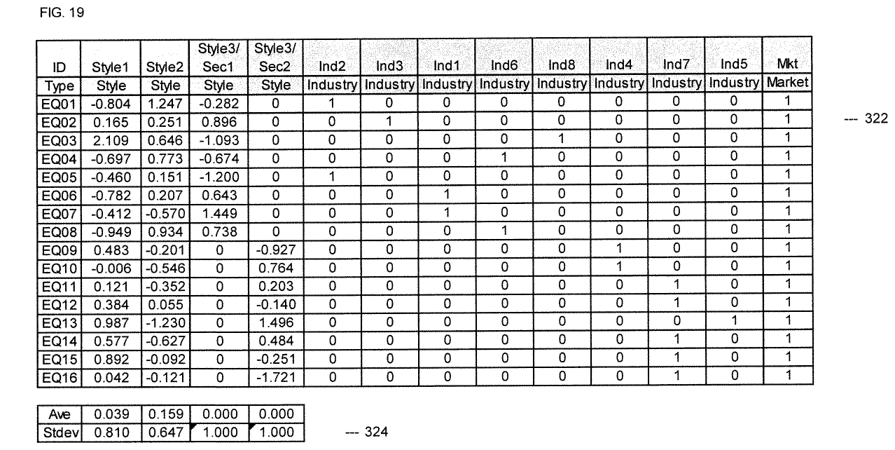

Table 322 in FIG. 19 illustrates the modified exposure matrix associated with the new Style3 sector risk model. All the exposures of “Style3/Sec1” to the sector Sec2 are zero, and all the exposures of “Style3/Sec2” to the sector Sec1 are zero. Table 324 shows the cap-weighted average and the equi-weighted standard deviation of each of the four style factors in the Style3 sector risk model. As can be seen, “Style3/Sec1” and “Style3/Sec2” are true Z scores, with zero mean and unit standard deviation.

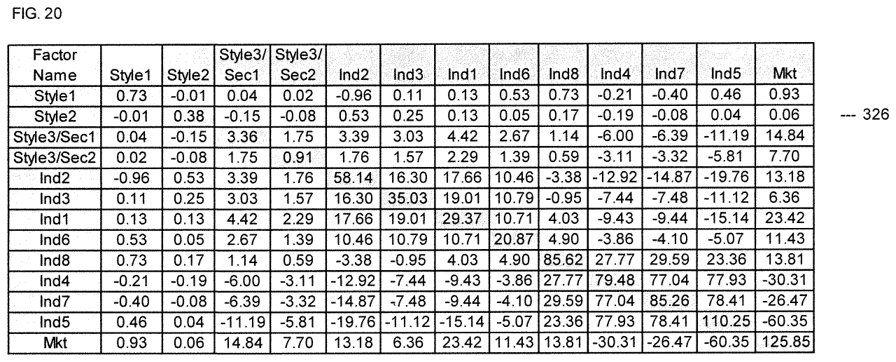

Table 326 in FIG. 20 gives the modified factor-factor covariance matrix, written in percent annual variance squared, for the Style3 sector risk model, which includes 13 factors.

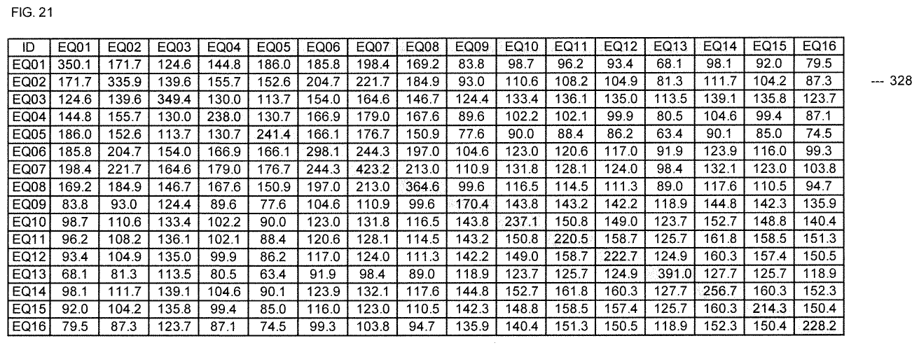

Table 328 in FIG. 21 shows the asset-asset covariance matrix, written in units of percent annual variance squared, derived from the Style3 sector risk model. This matrix is identical to table 312, illustrating that the modified factor risk model has the same asset level risk predictions.

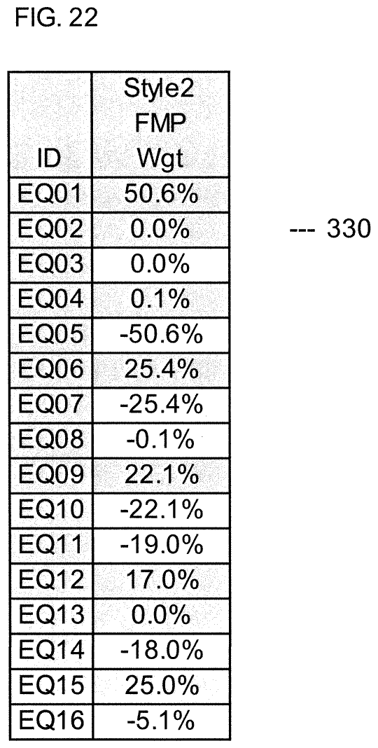

As a second illustration, the simple original factor risk model is taken, and the Style2 factor is split using a factor mimicking portfolio. Table 330 in FIG. 22 shows the factor mimicking portfolio associated with the Style2 factor, using market cap as the weighting. The assets with positive weights are shown in grey; the assets with negative weights are shown with the white background. This partition divides assets into over- and under-weights to partition the Style2 factor.

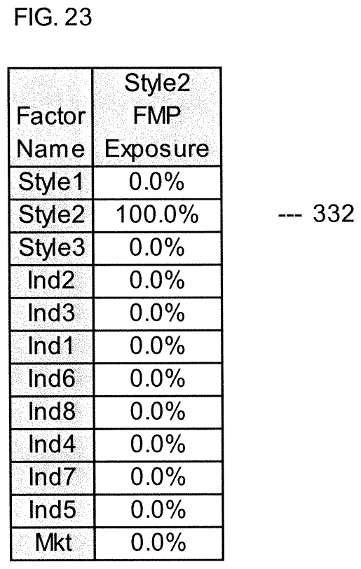

Table 332 in FIG. 23 gives the exposure of the Style2 factor mimicking portfolio 330 to each of the original risk model factors. As intended, the exposure to Style2 is 100% while the exposure to each of the other factors vanishes. This is the defining characteristics of a factor mimicking portfolio.

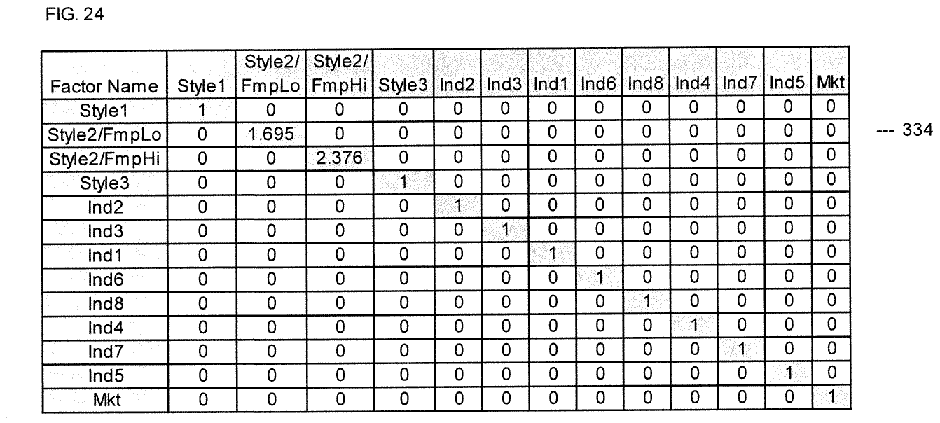

In this example, the new factor exposures are rescaled so that their equi-weighted standard deviation is one. The cap-weighted mean of the new factors is not set to zero, as that cannot be done without altering the sparsity of the factor exposures. Table 334 in FIG. 24 gives the linear transformation matrix U that rescales the split Style2 factors.

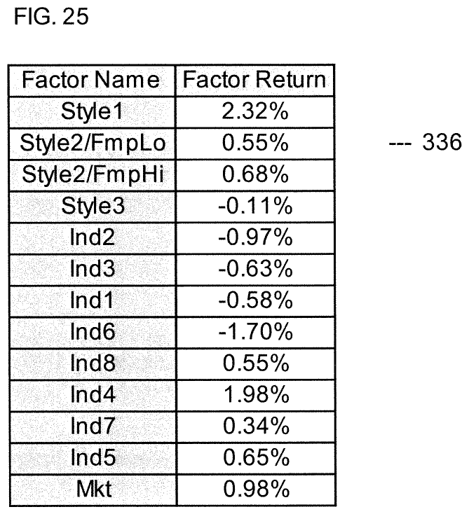

Table 336 in FIG. 25 gives the modified factor returns for the FMP over-weight and under-weight Style2 factor risk model. As before, the factor returns of the unchanged factors have not changed.

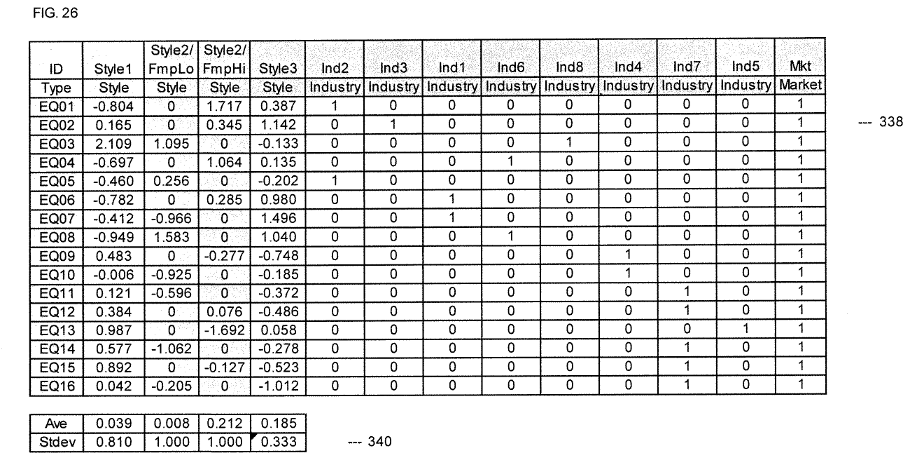

Table 338 in FIG. 26 gives the modified factor exposures for the FMP over-weight and under-weight Style2 factor risk model. The vanishing exposures due to the partitioning are highlighted in grey. Table 340 gives the cap-weighted average and the equi-weighted standard deviation for each of the four style factors in the modified factor risk model. As intended, the standard deviation of the non-zero split factor exposures is one. The mean is not zero.

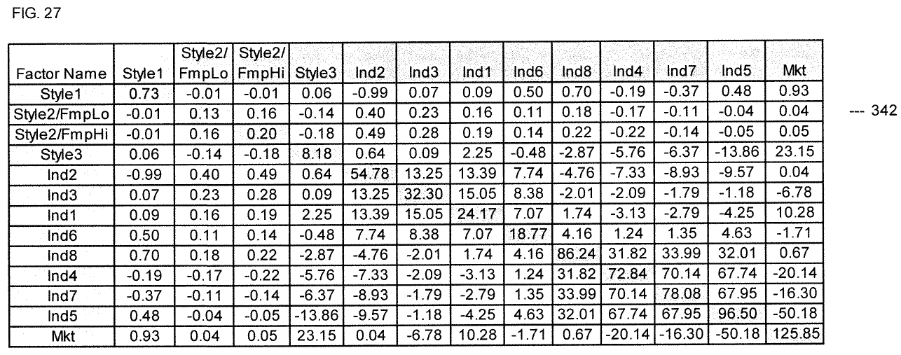

Table 342 in FIG. 27 gives the modified factor-factor covariance matrix for the FMP over-weight and under-weight Style2 factor risk model in units of percent annual variance squared.

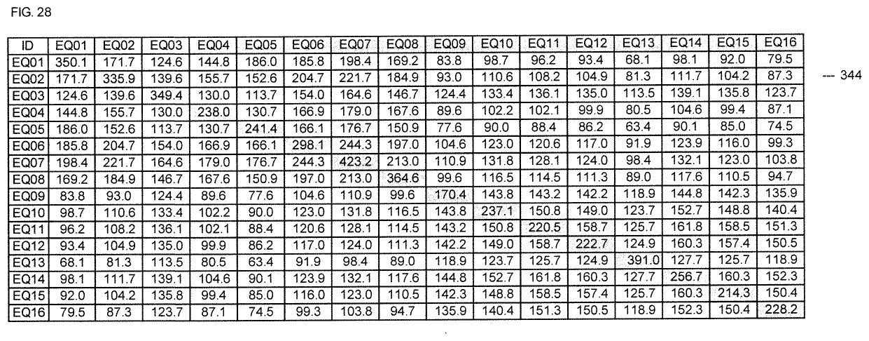

Table 344 in FIG. 28 gives the asset-asset covariance matrix, in units of percent annual variance squared, derived from the FMP over-weight and under-weight Style2 factor risk model. As intended, this matrix is identical to the matrices of table 312 and table 328, illustrating that the risk model transformations have not altered the asset level risk predictions.

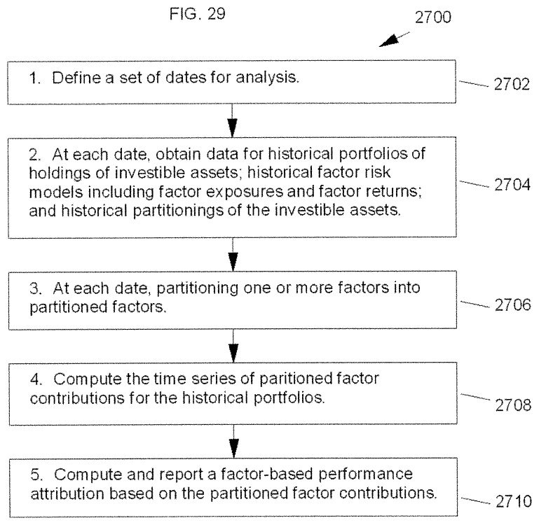

FIG. 29 shows a flow diagram illustrating the steps of a process 2700 embodying the present invention as applied to performance attribution. In step 2702, a set of dates is defined over which the performance attribution will be performed.

In step 2704, at each date, data is obtained for the historical portfolio holdings; the original factor risk models including factor exposures, and factor returns; and a set of asset partitions for splitting at least one of the original risk model factors. As an example, computer 12 downloads such data from server 28 storing it in memory, a database, or the like, for subsequent use as inputs 30.

In step 2706, at each date, one or more factors of the original factor risk model is split into the split factors using the asset partition. For example, in one of the examples illustrated above, the style factor “Style 3” was split across two sectors, “Sec1” and “Sec2” resulting in a replacement of the original “Style 3” factor with the “Style 3/Sec1” factor and the “Style 3/Sec2” factor, as shown in table 322. In a second example, the “Style 2” factor was split into “Style 2/FmpLo” and “Style 2/FmpHi”, as shown in table 338.

In step 2708, at each date, the factor contributions of the split factors for the historical portfolio holdings are computed. For example, each factor contribution may be calculated as a sum of a product of an investment asset weight for an asset in the partitioning group, an asset exposure from the factor exposure matrix, and a factor return from the factor return vector.

Finally, in step 2710, the time series of split factor contributions are used to compute and report factor-based performance attribution of the historical portfolio holdings. The attribution may include contribution linking. As one example, table 208 lists the ranked, performance contributions of the style factors of an original factor risk model split into FMP Hi and FMP Lo buckets. Table 212 shows the ranked, performance contributions of the style factors of an original factor risk model split across three alpha buckets, HI, Medium, and LO.

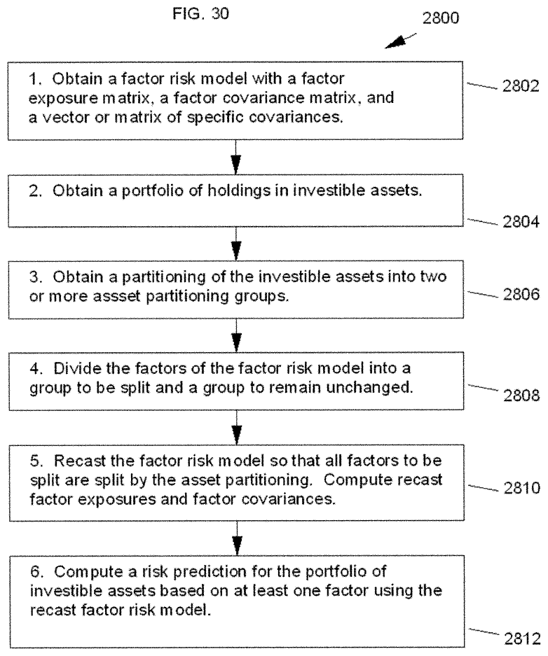

FIG. 30 shows a second flow diagram illustrating the steps of a process 2800 embodying the present invention as applied to risk prediction. In step 2802, a factor risk model with a factor exposure matrix, a factor covariance matrix, and a vector or matrix of specific covariances are obtained.

In step 2804, data is obtained for a portfolio of holdings in investible assets. For example, table 314 gives a benchmark portfolio of holdings in 16 investible assets.

In step 2806, a partitioning of the investible assets into two or more asset partitioning groups is made. Each investible asset can belong to one and only one partition group. For example, investable assets may be partitioned by industry, industry sub-group, industry group, sector, country, region, economic level, or currency. Alternatively, the partitioning groups may be based on ranking a vector of assets attributes and dividing assets into groups based on the ranking.

In step 2808, the factors of the factor risk model are divided into two groups, a first group of factors to be split and a second group of factors that is to remain unchanged. For example, in one example given above, the “Style 3” factor is split while the other factors of the original factor risk model remain unchanged. In another example, the “Style 2” factor is split while the other factors of the original factor risk model remain unchanged.

In step 2810, the factor risk model is recast so that all factors to be split are split by the asset partitioning. The recast factor risk model has a modified factor exposure matrix and a modified factor covariance matrix. For example, tables 320, 322, and 326 show the factor return, exposure matrix, and factor covariance matrix of a modified factor risk model in which the Style 3 factor has been split across the sectors Sec1 and Sec2. Tables 336, 338 and 342 give the factor return, exposure matrix, and factor covariance matrix of a modified factor risk model in which the Style 2 factor has been split by the FmpLo and FmpHi exposures.

Finally, in step 2812, a risk prediction for the portfolio of holdings based on at least one factor in the recast factor risk model is computed. For example, if w is a column vector of holdings in the 16 investment opportunities shown in table 314, then the risk associated with that portfolio is given by the square root of the matrix product of w, Q, and w transpose, where Q, the asset-asset covariance matrix, is shown in tables 312, 328, or 344, each of which is identical even though they are represented by factor risk models with different sets of factors.

While the present invention has been disclosed in the context of various aspects of presently preferred embodiments, it will be recognized that the invention may be suitable applied to other environments consistent with the claims which follow.

I claim:

1. A computer-implemented method for computing and reporting the performance attribution of a set of portfolio holdings over time by providing a tool for display of results facilitating appreciation of performance attribution on a more granular basis, the method comprising:
electronically receiving and storing by the programmed computer a set of dates defining an attribution time horizon to be analyzed;
for each date, electronically receiving and storing by the programmed computer a historical portfolio of holdings having investment weights in a set of investible assets;
for each date, electronically receiving and storing by the programmed computer an original factor risk model modeling each investible asset in the historical portfolio of holdings as of that date, the original factor risk model comprising at least a set of factors, an original factor exposure matrix, and an original vector of factor returns;
for each date, electronically receiving and storing by the programmed computer a partitioning of the investible assets as of that date into two or more partitioning groups such that each investible asset belongs to one and only one of the partitioning groups;
for each date, electronically receiving and storing by the programmed computer a subset of factors to be partitioned which includes at least one original factor;
for each date, electronically calculating and storing by the programmed computer for the subset of factors to be partitioned a set of partitioned factor contributions, each partitioned factor contribution corresponding to a partitioning group, each partitioned factor contribution being computed as a sum of a product of an investment asset weight for an asset in the partitioning group, an asset exposure from the original factor exposure matrix, and a factor return from the original factor return vector;
computing a performance attribution analysis for the historical portfolios of holdings based on the partitioned factor contributions for each date;
tabulating a ranked listing by contribution for the partitioned factor contributions for each date to facilitate user selection of one or more partitioned factor contributions to be neutralized; and
outputting the performance attribution results using an output device.

2. The method of claim 1 further comprising:
identifying a worst factor contribution in the performance attribution and neutralizing the weight factor contribution.

3. The method of claim 1 further comprising:
creating a revised set of historical portfolios of holdings for each date in which one or more partitioned factor exposures, computed as the sum of a product of an investment asset weight for an asset in the partitioning group and an asset exposure from the original factor exposure matrix, has been systematically reduced; and
electronically evaluating and storing by the programmed computer the revised portfolio.

4. The method of claim 1 further comprising:
recasting the original factor risk model to include all the partitioned factors in such a way that any predicted asset-asset covariance for any pair of assets remains unchanged.

5. The method of claim 4 further comprising:
outputting the performance attribution including results based on a predicted risk from the recast factor risk model.

6. The method of claim 1 wherein the partitioning groups are based on asset assignments to industries, industry sub-groups, industry groups, sectors, countries, regions, economic level, and currencies, and ranking the partitioning groups in a table from highest to lowest.

7. The method of claim 1 wherein the partitioning groups are based on ranking a vector of asset attributes and dividing the assets into groups based on the ranking and ranking groups in a table to facilitate identification of a group which contributes little to performance.

8. The method of claim 7 in which the vector of asset attributes is one of an expected return, an expected return ranking, average daily volume, market capitalization, a measure of size, a measure of liquidity, a measure of volatility, a measure of market sensitivity, a measure of momentum, a measure of value, or a measure of growth.

9. A computer-implemented system for improved computing and reporting the performance attribution of a set of portfolio holdings over time by providing a tool for display of results facilitating appreciation of performance attribution on a more granular basis, the method comprising:
a memory storing data for a set of dates defining an attribution time horizon to be performed;
a processor executing software to operate:
to retrieve data for historical portfolios of holdings having investment weights in a set of investible assets at each date;
to retrieve data for an original factor risk model predicting risk for each investible asset in the historical portfolio of holdings at each date, the original factor risk model comprising at least a set of factors, an original factor exposure matrix and an original vector of factor returns;
to retrieve data for a partitioning of the investible assets as of that date into two or more partitioning groups such that each investible asset belongs to one and only one of the partitioning groups;
to retrieve data for a subset of factors to be partitioned which includes at least one original factor;
to compute for each date and set of factors to be partitioned, a set of factor contributions, each partitioned factor contribution corresponding to a partitioning group, each partitioned factor contribution being computed as a sum of a product of an investment asset weight for an asset in the partitioning group, an original asset exposure from the factor exposure matrix, and a factor return from the original factor return vector;
to compute a performance attribution analysis for the historical portfolios of holdings based on the partitioned factor contributions for each date;
to tabulate a ranked listing by contribution for the partitioned factor contributions for each date to facilitate user selection of one or more partitioned factor contributions to be neutralized; and
electronically outputting the performance attribution results on an output device.

10. The system of claim 9 in which a worst factor contribution in the performance attribution is identified.

11. The system of claim 9 in which a revised set of historical portfolios of holdings for each date is computed so that one or more partitioned factor exposures, computed as the sum of a product of an investment asset weight for an asset in the partitioning group and an asset exposure from the original factor exposure matrix, has been systematically reduced is computed by the processor.

12. The system of claim 9 in which the original factor risk model is recast to include the set of partitioned factors in such a manner that any predicted asset-asset covariance for any pair of assets remains unchanged.

13. The system of claim 12 in which the performance attribution includes results based on a predicted risk from the recast factor risk model.

14. The system of claim 9 in which the partitioning groups are based on asset assignments to industries, industry sub-groups, industry groups, sectors, countries, regions, economic level, or currencies.

15. The system of claim 9 wherein the partitioning groups are based on ranking a vector of asset attributes and dividing the assets into groups based on the ranking.

16. The system of claim 15 wherein the vector of asset attributes is one of an expected return, an expected return ranking, average daily volume, market capitalization, a measure of size, a measure of liquidity, a measure of volatility, a measure of market sensitivity, a measure of momentum, a measure of value, or a measure of growth.

17. A computer-implemented method for computing and reporting factor contributions for a set of portfolio holdings over time by providing a tool for display of results facilitating appreciation of performance attribution on a more granular basis, the method comprising:
electronically receiving and storing by a programmed computer a set of dates defining a time horizon for the computation;
for each date, electronically receiving and storing by the programmed computer a historical portfolio of holdings having investment weights in a set of investible assets;
for each date, electronically receiving and storing by the programmed computer a set of factors, a set of original factor exposures for each factor and each investible asset in the historical portfolio of holdings, and an original factor return for each factor;
for each date, electronically receiving and storing by the programmed computer a partitioning of the investible assets as of that date into two or more partitioning groups such that each investible asset belongs to one and only one of the partitioning groups;
for each date, electronically receiving and storing by the programmed computer a subset of factors to be partitioned which includes at least one original factor;
for each date, electronically computing and storing by the programmed computer for the set of original factors to be partitioned, a set of partitioned factor contributions, each partitioned factor contribution corresponding to a partitioning group, each partitioned factor contribution being computed as a sum of a product of an investment asset weight for an asset in the partitioning group, an original factor exposure, and an original factor return;
computing an aggregated summary of factor contributions over the time horizon;
tabulating a ranked listing by contribution for the partitioned factor contributions for each date to facilitate user selection of one or more partitioned factor contributions to be neutralized; and
electronically outputting the aggregated partitioned factor contributions.

18. The method of claim 17 further comprising:
identifying a worst factor contribution in the performance attribution.

19. The method of claim 17 further comprising:
creating a revised set of historical portfolios of holdings for each date in which one or more partitioned factor exposures, computed as the sum of a product of an investment asset weight for an asset in the partitioning group and an original asset exposure from the factor exposure matrix, has been systematically reduced and electronically received and stored by the programmed computer.

20. The method of claim 17 wherein the partitioning groups are based on asset assignments to industries, industry sub-groups, industry groups, sectors, countries, regions, economic level, or currencies.
